(19) United States
(12) Patent Application Publication
(10) Pub. No.: US 2025/0329203 A1
(43) Pub. Date: Oct. 23, 2025

(54) PRIVILEGE INFORMATION ISSUING APPARATUS, SYSTEM, AND METHOD, AND COMPUTER READABLE MEDIUM

(71) Applicant: NEC Corporation, Minato-ku, Tokyo (JP)

(72) Inventors: Eri KOKAJI, Tokyo (JP); Kazufumi HOSHI, Tokyo (JP); Yurie HOSHI, Tokyo (JP); Hiroaki KUJIRAI, Tokyo (JP)

(73) Assignee: NEC Corporation, Minato-ku, Tokyo (JP)

(21) Appl. No.: 18/861,638

(22) PCT Filed: Jul. 28, 2022
(86) PCT No.: PCT/JP2022/029074

§ 371 Date: Oct. 30, 2024

(51) Int. Cl. G07C 9/27; G06Q 10/02; G06Q 20/32; G06Q 20/40; G07C 9/22

(52) U.S. Cl. CPC G07C 9/27; G06Q 10/02; G06Q 20/3274; G06Q 20/40145; G07C 9/22

(57) ABSTRACT

A privilege information issuing apparatus includes: an issuing unit that issues, for a user who has purchased entry qualification information that enables the user to enter an event venue through identity authentication, first privilege information that can be used in a first facility which is any one of a first commercial facility inside the event venue and a second commercial facility in a neighborhood of the event venue and second privilege information in which an availability condition has been set, the availability condition being a condition that the second privilege information is able to be used in a second facility, by a consumption action using the first privilege information being carried out in the first facility; and a notification unit that notifies a terminal of the user of a set of the first and second privilege information and the availability condition set in the second privilege information.

### TECHNICAL FIELD

The present disclosure relates to a privilege information issuing apparatus, a system, a method, and a program.

### BACKGROUND ART

A unique economic zone can be formed in a predetermined region including an event venue and commercial facilities around the event venue. Patent Literature 1 discloses a technology related to a region information providing system that can obtain information regarding other stores and facilities in a surrounding region, coupon tickets, and the like. Users of Patent Literature 1 obtain coupons by shopping or eating at service stores. Then, regional stores located in the surrounding region of the service stores give privileges such as discounting to users who present obtained coupons via a wireless LAN.

In recent years, provision of services using biometric authentication such as face authentication has been put into practical use.

### CITATION LIST

### Patent Literature

Patent Literature 1: Japanese Unexamined Patent Application Publication No. 2003-228637

### SUMMARY OF INVENTION

### Technical Problem

Here, in a predetermined region including an event venue and commercial facilities around the event venue, activating the region by mutually sending customers between the event venue and the commercial facilities is required. According to Patent Literature 1 described above, there is room for improvement in cooperative utilization of the event venue and the surrounding commercial facilities.

In view of the aforementioned problems, an object of the present disclosure is to provide a privilege information issuing apparatus, a system, a method, and a program to promote cooperative utilization of an event venue and commercial facilities around the event venue.

### Solution to Problem

A privilege information issuing apparatus according to the present disclosure includes:
an issuing means for issuing, for a user who has purchased entry qualification information that enables the user to enter an event venue through identity authentication, first privilege information that is able to be used in a first facility which is any one of a first commercial facility inside the event venue and a second commercial facility in a neighborhood of the event venue and second privilege information in which an availability condition has been set, the availability condition being a condition that the second privilege information is able to be used in a second facility which is the other one of the first commercial facility and the second commercial facility, the second facility being different from the first facility, by a consumption action using the first privilege information being carried out in the first facility; and
a notification means for notifying a terminal of the user of a set of the first privilege information and the second privilege information and the availability condition set in the second privilege information.

A privilege information issuing system according to the present disclosure includes:
a storage apparatus that stores first privilege information that is able to be used in a first facility which is any one of a first commercial facility inside an event venue and a second commercial facility in a neighborhood of the event venue and second privilege information that is able to be used in a second facility which is the other one of the first commercial facility and the second commercial facility, the second facility being different from the first facility; and
a privilege information issuing apparatus that is connected to the storage apparatus,
in which the privilege information issuing apparatus includes
an issuing means for issuing, for a user who has purchased entry qualification information that enables the user to enter the event venue through identity authentication, the first privilege information and the second privilege information in which an availability condition has been set with reference to the storage apparatus, the availability condition being a condition that the second privilege information is able to be used by a consumption action using the first privilege information being carried out in the first facility, and
a notification means for notifying a terminal of the user of a set of the first privilege information and the second privilege information and the availability condition set in the second privilege information.

A privilege information issuing method according to the present disclosure causes a computer to:
issue, for a user who has purchased entry qualification information that enables the user to enter an event venue through identity authentication, first privilege information that is able to be used in a first facility which is any one of a first commercial facility inside the event venue and a second commercial facility in a neighborhood of the event venue and second privilege information in which an availability condition has been set, the availability condition being a condition that the second privilege information is able to be used in a second facility which is the other one of the first commercial facility and the second commercial facility, the second facility being different from the first facility, by a consumption action using the first privilege information being carried out in the first facility; and
notify a terminal of the user of a set of the first privilege information and the second privilege information and the availability condition set in the second privilege information.

A privilege information issuing program according to the present disclosure causes a computer to execute:
issuing processing of issuing, for a user who has purchased entry qualification information that enables the user to enter an event venue through identity authentication, first privilege information that is able to be used in a first facility which is any one of a first commercial facility inside the event venue and a second commercial facility in a neighborhood of the event venue and second privilege information in which an availability condition has been set, the availability condition being a condition that the second privilege information is able to be used in a second facility which is the other one of the first commercial facility and the second commercial facility, the second facility being different from the first facility, by a consumption action using the first privilege information being carried out in the first facility; and
notification processing of notifying a terminal of the user of a set of the first privilege information and the second privilege information and the availability condition set in the second privilege information.

### Advantageous Effects of Invention

According to the present disclosure, it is possible to provide a privilege information issuing apparatus, a system, a method, and a program to promote cooperative utilization of an event venue and commercial facilities around the event venue.

### BRIEF DESCRIPTION OF DRAWINGS

FIG. 1 is a block diagram illustrating a configuration of a privilege information issuing apparatus according to a first example embodiment.

FIG. 2 is a flowchart illustrating a flow of a privilege information issuing method according to the first example embodiment.

FIG. 3 is a block diagram illustrating an overall configuration of a privilege information issuing system according to a second example embodiment.

FIG. 4 is a block diagram illustrating a configuration of an authentication apparatus according to the second example embodiment.

FIG. 5 is a block diagram illustrating a configuration of a user terminal according to the second example embodiment.

FIG. 6 is a block diagram illustrating a configuration of an entry control terminal according to the second example embodiment.

FIG. 7 is a block diagram illustrating a configuration of a payment terminal according to the second example embodiment.

FIG. 8 is a block diagram illustrating a configuration of a privilege information issuing apparatus according to the second example embodiment.

FIG. 9 is a sequence diagram illustrating a flow of privilege information registration processing according to the second example embodiment.

FIG. 10 is a flowchart illustrating a flow of user information registration processing according to the second example embodiment.

FIG. 11 is a flowchart illustrating a flow of face information registration processing performed by the authentication apparatus according to the second example embodiment.

FIG. 12 is a sequence diagram illustrating a flow of entry qualification information registration processing according to the second example embodiment.

FIG. 13 is a flowchart illustrating a flow of face authentication processing performed by the authentication apparatus according to the second example embodiment.

FIG. 14 is a flowchart illustrating a flow of privilege information issuing processing according to the second example embodiment.

FIG. 15 is a flowchart illustrating a flow of target specification processing according to Example 2-1 of the second example embodiment.

FIG. 16 is a flowchart illustrating a flow of target specification processing according to Example 2-2 of the second example embodiment.

FIG. 17 is a flowchart illustrating a flow of target specification processing according to Example 2-3 of the second example embodiment.

FIG. 18 is a diagram illustrating Display Example 2-1 of a set of privilege information on the user terminal according to the second example embodiment.

FIG. 19 is a diagram illustrating Display Example 2-2 of a set of privilege information on the user terminal according to the second example embodiment.

FIG. 20 is a sequence diagram illustrating a flow of first privilege information utilization processing performed by a user according to the second example embodiment.

FIG. 21 is a flowchart illustrating a flow of privilege information utilization processing according to the second example embodiment.

FIG. 22 is a flowchart illustrating a flow of privilege information utilization processing according to the second example embodiment.

FIG. 23 is a diagram illustrating a display example of a privilege information availability notification on the user terminal according to the second example embodiment.

FIG. 24 is a sequence diagram illustrating a flow of second privilege information utilization processing performed by the user according to the second example embodiment.

FIG. 25 is a diagram illustrating a display example after utilization of privilege information on the user terminal according to the second example embodiment.

FIG. 26 is a flowchart illustrating a flow of privilege information issuing processing according to a third example embodiment.

FIG. 27 is a diagram illustrating Display Example 3-1 of a set of privilege information on a user terminal according to the third example embodiment.

FIG. 28 is a diagram illustrating Display Example 3-2 of a set of privilege information on the user terminal according to the third example embodiment.

### EXAMPLE EMBODIMENT

Hereinafter, example embodiments of the present disclosure will be described in detail with reference to the drawings. In the drawings, the same or corresponding elements are denoted by the same reference numerals, and repeated descriptions will be omitted as necessary for clarity of description.

### First Example Embodiment

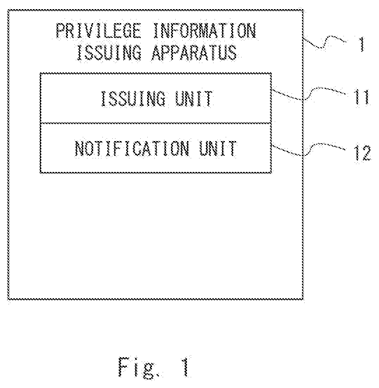

FIG. 1 is a block diagram illustrating a configuration of a privilege information issuing apparatus 1 according to a first example embodiment. The privilege information issuing apparatus 1 is an information processing apparatus that issues privilege information available in a commercial facility. The “commercial facility” is a store or the like that sells products or provides services. The commercial facility according to the first example embodiment is assumed to be present in a region within a predetermined range from an event venue where a predetermined event is held. Therefore, the commercial facility is either a first commercial facility that is present inside the event venue or a second commercial facility around the event venue, that is, in the neighborhood of the event venue. In addition, the “privilege information” is electronic data to which a right to enjoy a paid privilege or a free privilege in an available facility has been given. The privilege information is, for example, value added information such as an electronic coupon or a point.

The privilege information issuing apparatus 1 includes an issuing unit 11 and a notification unit 12. The issuing unit 11 issues privilege information for a user who has purchased entry qualification information such as an entry ticket of an event venue. Here, the “entry qualification information” is information proving that the user can enter the event venue through identity authentication. Also, the “identity authentication” is information processing of collating identity authentication information registered in advance with information acquired from the individual at the time of authentication or input from the individual and confirming authenticity of the individual by a matching degree being equal to or greater than a threshold value. Although examples of the identity authentication include biometric authentication such as face authentication, collation of code information (such as an ID or a password) presented or input by the individual, and the like, the identity authentication is not limited thereto.

The issuing unit 11 issues, for the user who has purchased the above entry qualification information, first privilege information that can be used in a first facility and second privilege information that can be used in a second facility by satisfying a predetermined availability condition. Here, the “first facility” is any one of the first commercial facility inside the event venue and the second commercial facility in the neighborhood of the event venue, and the “second facility” is the other one of the first commercial facility and the second commercial facility. The second facility is different from the first facility. Note that each of the first commercial facility and the second commercial facility may be a group of commercial facilities. For example, in a case where the first facility is one of the first commercial facility group, the second facility is one of the second commercial facility group. Also, in a case where the first facility is one of the second commercial facility group, the second facility is one of the first commercial facility group. Furthermore, the “availability condition” indicates that the user carries out a consumption action using the first privilege information in the first facility. Therefore, it is possible to state that the “second privilege information” is privilege information in which an availability condition that the second privilege information can be used in the second facility by the user carrying out a consumption action using the first privilege information in the first facility has been set. In other words, it is assumed that although the second privilege information is issued together with the first privilege information, the second privilege information cannot be used at the time of the issuing. Furthermore, the issuing unit 11 issues such a set of the first privilege information and the second privilege information.

The notification unit 12 notifies the terminal of the user as a target of issuing of the set of the first privilege information and the second privilege information and the availability condition set in the second privilege information. In this manner, the user can grasp the set of the first privilege information and the second privilege information and the availability condition set in the second privilege information designated in the notification via the terminal of the user himself/herself.

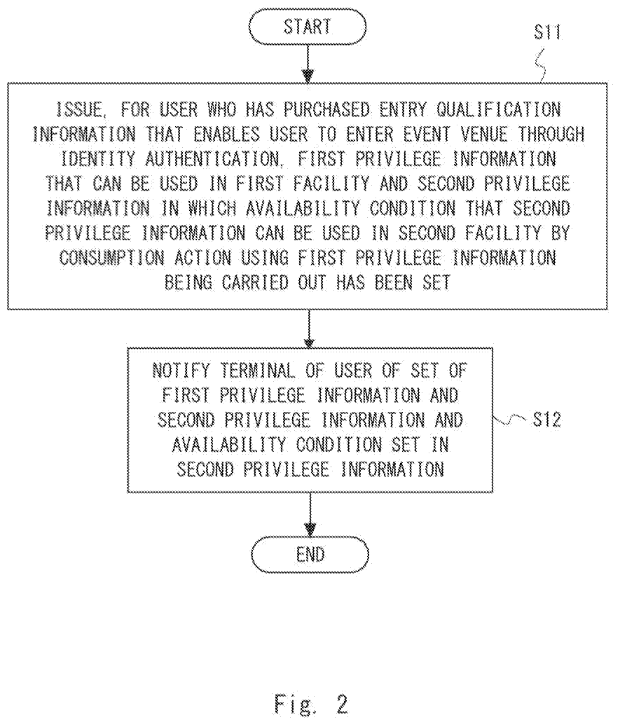

FIG. 2 is a flowchart illustrating a flow of privilege information issuing method according to the first example embodiment. First, the issuing unit 11 issues, for the user who has purchased the entry qualification information that enables the user to enter the event venue through identity authentication, first privilege information that can be used in the first facility and second privilege information in which the predetermined availability condition has been set (S11). Here, the predetermined availability condition is a condition that the second privilege information can be used in the second facility by the user carrying out the consumption action using the first privilege information in the first facility as described above.

Then, the notification unit 12 notifies the terminal of the user of the set of the first privilege information and the second privilege information and the availability condition set in the second privilege information (S12).

In this manner, according to the first example embodiment, the privilege information that can be used in each of the first commercial facility inside the event venue and the second commercial facility in the neighborhood of the event venue is issued as a set in the user who has purchased the entry qualification information of the event venue. At this time, the first privilege information can be used in the first facility that is any one of the first commercial facility and the second commercial facility, and the second privilege information can be used in the second facility that is the other one of the first commercial facility and the second commercial facility in a case where the predetermined availability condition is satisfied. Then, the user can grasp that the set of the first privilege information and the second privilege information has been issued on the terminal of the user himself/herself and that the second privilege information cannot be used at the present time but can be used after the consumption action using the first privilege information in the first facility, in response to the notification. Therefore, the user is given two motivations for carrying out a consumption action such as purchase of a product or payment for a service provided in the first facility. In other words, since the user can enjoy the privilege based on the first privilege information in the first facility and also enjoy the privilege based on the second privilege information in the second facility as well, the desire of purchase is increased. In other words, the privilege information issuing apparatus 1 notifies the user of the point that the second privilege information will be able to be used by using the first privilege information, thereby promoting the user to use the first privilege information in the first facility. For example, the user is more likely to carry out the consumption action while enjoying the privilege in the second commercial facility in the neighborhood of the event venue with the motivation that the user can enjoy the privilege in the first commercial facility inside the event venue. Similarly, the user is more likely to carry out the consumption action while enjoying the privilege in the first commercial facility inside the event venue with the motivation that the user can enjoy the privilege in the second commercial facility in the neighborhood of the event venue. Therefore, it is possible to activate the region by mutually sending customers between the event venue and the commercial facilities around the event venue. Therefore, it is possible to promote cooperative utilization of the event venue and the commercial facilities around the event venue.

Note that the privilege information issuing apparatus 1 includes a processor, a memory, and a storage apparatus as configurations, which are not illustrated. In addition, the storage apparatus stores a computer program that implements processing of the privilege information issuing method according to the present example embodiment. Then, the processor reads a computer program or the like from the storage apparatus into the memory and executes the computer program. In this manner, the processor implements the functions of the issuing unit 11 and the notification unit 12.

Alternatively, each component of the privilege information issuing apparatus 1 may be implemented by dedicated hardware. In addition, some or all of the components of each apparatus may be implemented by general-purpose or dedicated circuitry, a processor, or a combination thereof. These may be configured of a single chip or may be configured of a plurality of chips connected via a bus. Some or all of the components of each apparatus may be implemented by a combination of the aforementioned circuitry or the like and a program. Furthermore, as the processor, a central processing unit (CPU), a graphics processing unit (GPU), a field-programmable gate array (FPGA), a quantum processor (quantum computer control chip), or the like can be used.

In a case where some or all of the components of the privilege information issuing apparatus 1 are implemented by a plurality of information processing apparatuses, circuits, or the like, the plurality of information processing apparatuses, circuits, or the like may be arranged in a centralized manner or in a distributed manner.

For example, the information processing apparatuses, the circuits, or the like may be implemented in the form of a client server system, a cloud computing system, or the like in which they are connected to each other via a communication network. The functions of the privilege information issuing apparatus 1 may be provided in a software as a service (SaaS) format.

### Second Example Embodiment

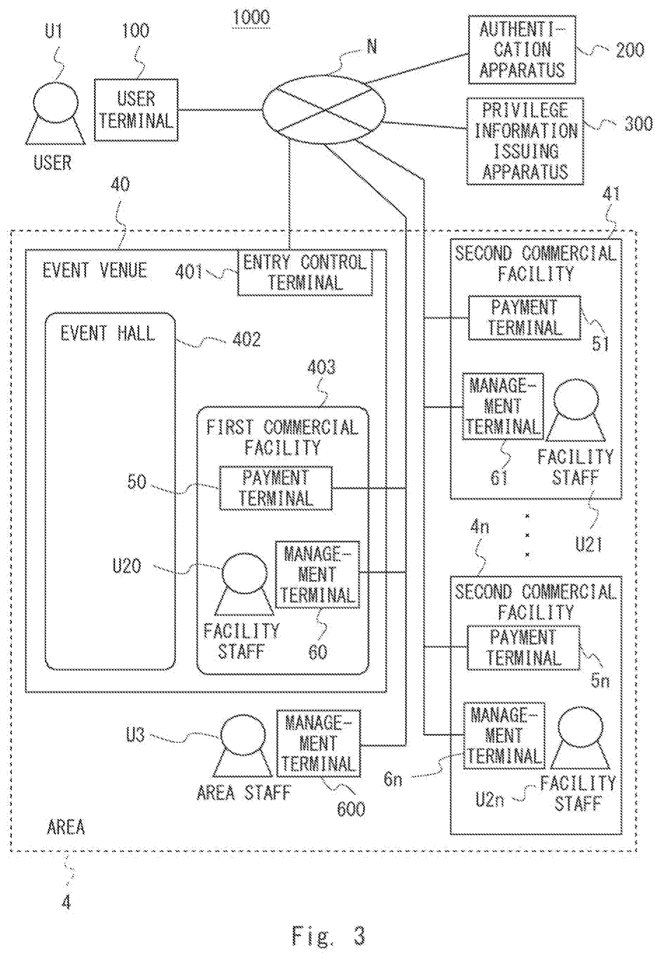

A second example embodiment is a specific example of the first example embodiment described above. FIG. 3 is a block diagram illustrating an overall configuration of a privilege information issuing system 1000 according to the second example embodiment. The privilege information issuing system 1000 is an information system for assisting mutual sending of customers in an area 4 including an event venue 40 and second commercial facilities 41 to 4n (n is a natural number that is equal to or greater than one) in the neighborhood thereof. Specifically, the privilege information issuing system 1000 issues a set of a first coupon and a second coupon for a user U1 who has purchased a paid ticket (entry qualification information) of the event venue 40, and notifies a user terminal 100 of the set of the first coupon and the second coupon, thereby assisting promotion of cooperative utilization between the facilities. Here, the first coupon is an example of the first privilege information described above, and the second coupon is an example of the second privilege information described above.

The event venue 40 is a site where a predetermined event is held. The “event” is a paid service provided at a certain time by collecting a large number of people. For example, the event is a sport game, a concert, an exhibition, an international conference, a test, or the like, and may be watched or viewed by visitors who have made payment, or the visitors themselves may participate in the event. Therefore, the event venue 40 is a facility such as a sport stadium, a sport ground, an arena, a theater, or a multiuse event hall, for example. The event venue 40 can also be referred to as a main facility or a core facility in the area 4.

It is assumed that the event venue 40 includes an event hall 402 and a first commercial facility 403, and an entry control terminal 401 is installed at an entrance. The entry control terminal 401 is an information terminal that permits entry into the event venue 40 if a person scheduled to enter (user) has succeeded in face authentication. Details of the entry control terminal 401 will be described later. Note that some users entering the event venue 40 may enter without passing through the entry control terminal 401. In other words, the event venue 40 may allow users who have purchased conventional tickets or the like to enter without using identity authentication such as face authentication. The event hall 402 is a place where an event is held, a sport ground, an audience seat, or the like. The first commercial facility 403 is a restaurant accompanying the event hall 402, a shop selling goods such as a souvenir shop or a goods shop, a spa which is an added value facility of the event venue 40, or the like, and is a facility that can be used after entering the event venue 40. In the first commercial facility 403, at least a payment terminal 50 compatible with payment using face authentication is installed. In addition, a facility staff U20 performs management operations such as registration of privilege information that can be used in the first commercial facility 403 using a management terminal 60. The facility staff U20 may also serve as a shop staff of the first commercial facility 403. Alternatively, the facility staff U20 may be a business operator on the side of the event venue 40, the event, or the first commercial facility 403. Therefore, the facility staff U20 and the management terminal 60 may not necessarily be present inside the first commercial facility 403.

The second commercial facilities 41 to 4n are peripheral facilities of the event venue 40 or commercial facilities in the neighborhood. It is only necessary for the number of the second commercial facilities 41 and the like to be at least one or more. The second commercial facility 41 and the like are facilities having a cooperative relationship with the event venue 40 side. Therefore, the business operators of the second commercial facility 41 and the like are partner business operators who are different from business operators on the side of the event venue 40 and the first commercial facility 403. Examples of the second commercial facility 41 and the like include, but are not limited to, a retail store, a restaurant, a shopping street, a shopping mall, an accommodation facility, a parking space, a bicycle-parking space, a transportation station (a railway station, a bus stop, a taxi stop, a port, or an airport), an amusement park, and the like.

In the second commercial facilities 41 to 4n, at least payment terminals 51 to 5n compatible with payment using face authentication are installed. In addition, facility staff U21 to U2n perform management operations such as registration of privilege information that can be used in the second commercial facilities 41 to 4n using management terminals 61 to 6n. The facility staff U21 and the like may also serve as shop staff of the second commercial facility 41 and the like. Alternatively, the facility staff U21 and the like may be partner business operators on the side of the second commercial facility 41 and the like. Therefore, the facility staff U21 and the like and the management terminal 61 and the like may not necessarily be present inside the second commercial facility 41 and the like.

An area staff U3 is a business operator who manages business in the area 4 including the event venue 40, the second commercial facility 41, and the like. The area staff U3 may register a combination of privilege information that can be used in the first commercial facility 403 and privilege information that can be used in the second commercial facility 41 and the like using a management terminal 600. At this time, the area staff U3 may set the first privilege information (first coupon), privilege content, and the like which are availability conditions of the second privilege information (second coupon). Note that known information processing apparatuses can be used as the management terminals 60, 61 to 6n, and 600, and illustration and detailed description thereof will thus be omitted.

Here, the privilege information issuing system 1000 includes the user terminal 100, an authentication apparatus 200, a privilege information issuing apparatus 300, the entry control terminal 401, the payment terminals 50 and 51 to 5n, and the management terminals 60, 61 to 6n, and 600. Each of the user terminal 100, the authentication apparatus 200, the privilege information issuing apparatus 300, the entry control terminal 401, the payment terminals 50 and 51 to 5n, the management terminals 60, 61 to 6n, and 600 is communicably connected via a network N. Here, the network N is a communication network including a wireless communication line and is, for example, the Internet, a wireless communication line network, a mobile phone line network, or the like. The network N may be of any type of communication protocol.

The authentication apparatus 200 is an information processing apparatus that manages face feature information of the user and performs face authentication. In response to a face authentication request received from the outside, the authentication apparatus 200 collates a face image or face feature information included in the request with the face feature information of each user, and returns the collation result (authentication result) to the request source.

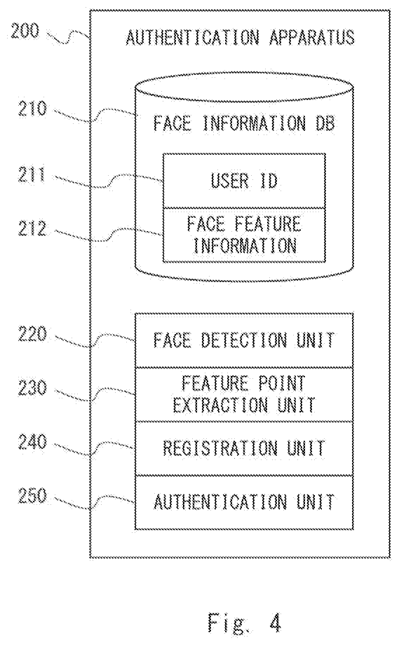

FIG. 4 is a block diagram illustrating the configuration of the authentication apparatus 200 according to the second example embodiment. The authentication apparatus 200 includes a face information database (DB) 210, a face detection unit 220, a feature point extraction unit 230, a registration unit 240, and an authentication unit 250. The face information DB 210 stores a user ID 211 and face feature information 212 of the user ID in association with each other. The face feature information 212 is a set of feature points extracted from the face image. Note that the authentication apparatus 200 may delete the face feature information 212 in the face information DB 210 in response to a request from the user or the like corresponding to the face feature information 212. Alternatively, the authentication apparatus 200 may delete the face feature information 212 after elapse of a predetermined period from registration.

The face detection unit 220 detects a face region included in a registered image for registering face information, and outputs the face region to the feature point extraction unit 230. The feature point extraction unit 230 extracts feature points from the face region detected by the face detection unit 220, and outputs the face feature information to the registration unit 240. In addition, the feature point extraction unit 230 extracts feature points included in the face image received from the privilege information issuing apparatus 300 or the like, and outputs the face feature information to the authentication unit 250.

The registration unit 240 newly issues the user ID 211 at a time of registering the face feature information. The registration unit 240 registers the issued user ID 211 and the face feature information 212 extracted from the registered image in the face information DB 210 in association with each other. The authentication unit 250 performs face authentication using the face feature information 212. Specifically, the authentication unit 250 collates the face feature information extracted from the face image with the face feature information 212 in the face information DB 210. If the collation is successful, the authentication unit 250 specifies the user ID 211 associated with the collated face feature information 212. The authentication unit 250 returns the matching result of the face feature information to the request source as a face authentication result. Whether or not the pieces of face feature information match each other corresponds to whether or not authentication has been successful or failed. Note that the fact that the pieces of face feature information match each other refers to the case where the degree of matching is equal to or greater than a threshold value. In addition, it is assumed that the face authentication result includes the specified user ID if the face authentication has been successful.

Returning to FIG. 3, the description will be continued. The user U1 is a purchaser, an entry scheduled person, and an entering person of the entry qualification information of the event held at the event venue 40. The user terminal 100 is an information processing terminal that registers user information including the face image and the entry qualification information in the privilege information issuing apparatus 300 in advance in accordance with an operation of the user U1. Note that the user U1 may perform registration and the like of the user information using an information processing apparatus other than the user terminal 100. Furthermore, it is assumed that the user U1 enters the event venue 40 with the user terminal 100 carried with the user.

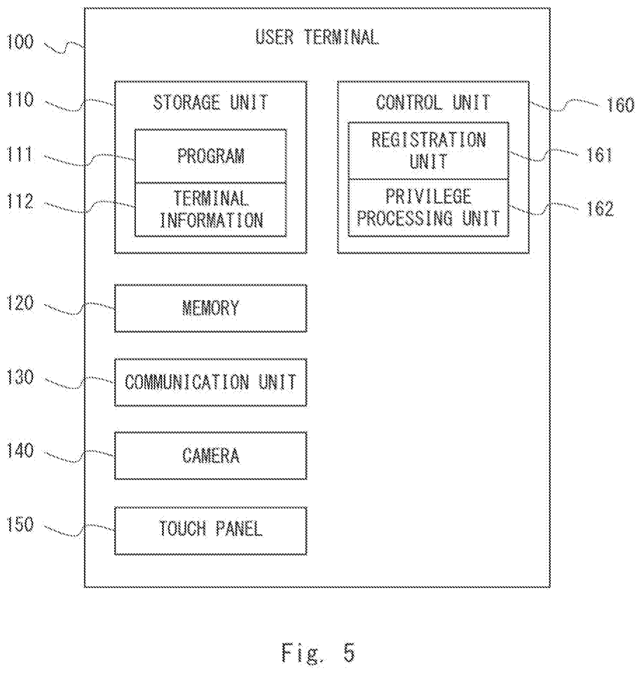

FIG. 5 is a block diagram illustrating a configuration of the user terminal 100 according to the second example embodiment. The user terminal 100 includes a storage unit 110, a memory 120, a communication unit 130, a camera 140, a touch panel 150, and a control unit 160. The storage unit 110 is an example of a nonvolatile storage device such as a flash memory. The storage unit 110 stores a program 111 and terminal information 112. The program 111 is a computer program in which processing such as registration of user information and entry qualification information, and inquiry, display, selection, and utilization of privilege information are mounted. The terminal information 112 is identification information and destination information of the user terminal 100.

The memory 120 is a volatile storage device such as a random access memory (RAM) and is a storage region for temporarily holding information during an operation of the control unit 160. The communication unit 130 is a communication interface with the network N.

The camera 140 is an imaging apparatus for imaging a region including the face of the user U1. The camera 140 outputs the captured image to the control unit 160. The touch panel 150 includes a display apparatus (display unit) such as a screen and an input apparatus.

The control unit 160 is a processor, that is, a control apparatus, that controls each configuration of the user terminal 100. The control unit 160 reads the program 111 from the storage unit 110 into the memory 120 and executes the program 111. In this manner, the control unit 160 implements the functions of the registration unit 161 and the privilege processing unit 162.

The registration unit 161 controls the camera 140, images the face of the user U1, and acquires the captured face image. Also, the registration unit 161 acquires attribute information and payment information input by the user U1 via the touch panel 150. In addition, the registration unit 161 reads and acquires the terminal information 112 from the storage unit 110. Then, the registration unit 161 transmits a registration request of the user information (member information) including the face image, the terminal information 112, the attribute information, and the payment information to the privilege information issuing apparatus 300. Furthermore, the registration unit 161 acquires entry qualification information purchased by the user U1. The registration unit 161 transmits a registration request including the face image of the user U1 and the entry qualification information to the privilege information issuing apparatus 300. Note that the registration unit 161 may include the entry qualification information in the registration request of the user information.

In response to a privilege issuing request provided through an instruction from the user U1 via the touch panel 150, the privilege processing unit 162 controls the camera 140, images the face of the user U1, and acquires the captured face image. Then, the privilege processing unit 162 transmits the privilege issuing request including the face image to the privilege information issuing apparatus 300. In addition, the privilege processing unit 162 receives a set of the first and second privilege information issued by the privilege information issuing apparatus 300 and a notification of an availability condition of the second privilege information and displays them on the touch panel 150. In addition, the privilege processing unit 162 transmits a privilege information inquiry request including the face image of the user U1 to the privilege information issuing apparatus 300 in response to the privilege inquiry request provided through an instruction from the user U1 via the touch panel 150. Then, the privilege processing unit 162 displays, on the touch panel 150, a list of the privilege information that has already been issued from the privilege information issuing apparatus 300 for the user U1. The privilege processing unit 162 displays the privilege information selected by the user U1 via the touch panel 150 in a selected state. In a case where the privilege processing unit 162 receives a privilege information update notification from the privilege information issuing apparatus 300, the privilege processing unit 162 displays the privilege information after update on the touch panel 150.

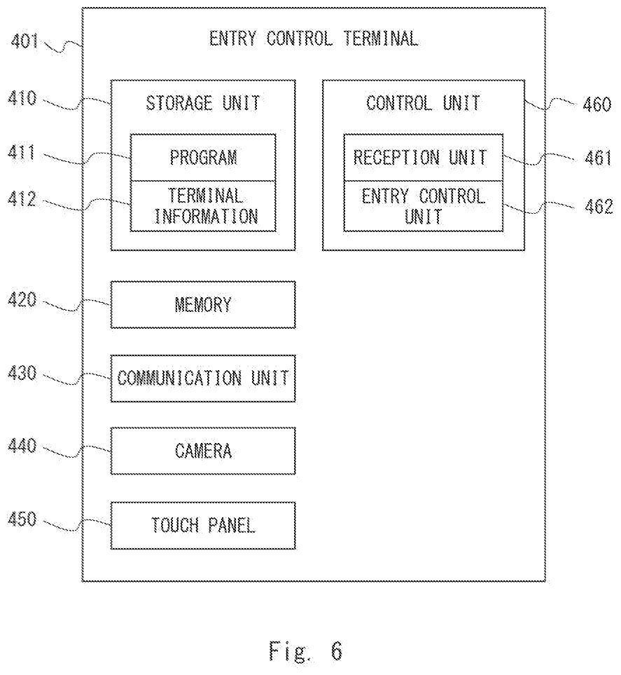

FIG. 6 is a block diagram illustrating a configuration of the entry control terminal 401 according to the second example embodiment. The entry control terminal 401 includes a storage unit 410, a memory 420, a communication unit 430, a camera 440, a touch panel 450, and a control unit 460. The storage unit 410 is an example of a nonvolatile storage device such as a flash memory. The storage unit 410 stores a program 411 and terminal information 412. The program 411 is a computer program in which the entry control processing and the like are mounted. The terminal information 412 is identification information and destination information of the entry control terminal 401.

The memory 420 is a volatile storage device such as a RAM, and is a storage region for temporarily holding information during operations of the control unit 460. The communication unit 430 is a communication interface with the network N.

The camera 440 is an imaging apparatus for imaging a region including a face of an entry scheduled person such as the user U1. The camera 440 outputs the captured image to the control unit 460. The touch panel 450 includes a display apparatus (display unit) such as a screen and an input apparatus.

The control unit 460 is a processor, that is, a control apparatus that controls each configuration of the entry control terminal 401. The control unit 460 reads the program 411 from the storage unit 410 into the memory 420 and executes the program 411. In this manner, the control unit 460 implements the functions of the reception unit 461 and the entry control unit 462.

The reception unit 461 receives the face image of the entry scheduled person captured by the camera 440 and outputs the face image to the entry control unit 462. The entry control unit 462 transmits an entry determination request including the face image output by the reception unit 461 and the terminal information 412 stored in the storage unit 110 to the privilege information issuing apparatus 300. Then, in a case where the entry control unit 462 receives an entry determination result from the privilege information issuing apparatus 300 and the entry determination result indicates permission of entry, the entry control unit 462 performs control to unlock an entrance gate (not illustrated) or the like of the event venue 40. Note that entry control terminal 401 may control an exit gate through face authentication at the time of exiting the site as well.

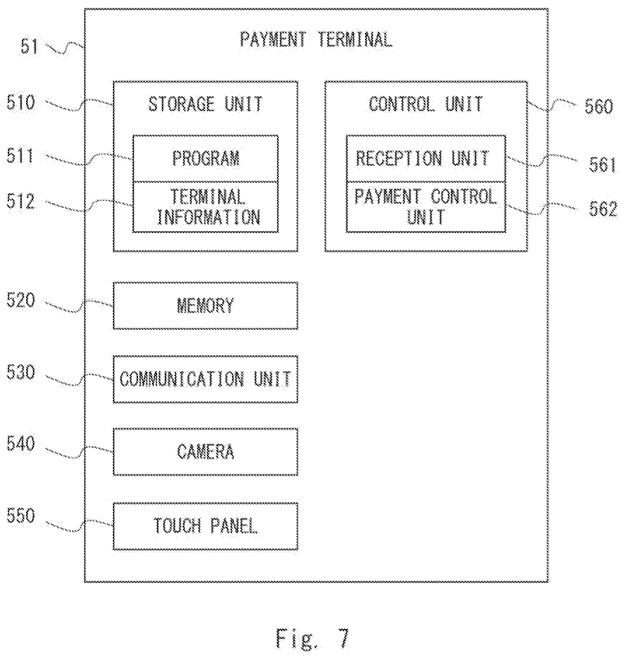

FIG. 7 is a block diagram illustrating a configuration of the payment terminal 51 according to the second example embodiment. Note that the configurations of the payment terminals 50 and 5n and the like are similar to those of the payment terminal 51, and illustration and detailed description thereof will thus be omitted. The payment terminal 51 includes a storage unit 510, a memory 520, a communication unit 530, a camera 540, a touch panel 550, and a control unit 560. The storage unit 510 is an example of a nonvolatile storage device such as a flash memory. The storage unit 510 stores a program 511 and terminal information 512. The program 511 is a computer program in which payment control processing and the like are mounted. The terminal information 512 is identification information and destination information of the payment terminal 51. In addition, the terminal information 512 is information with which the second commercial facility 41 where the terminal is placed can be specified.

The memory 520 is a volatile storage device such as a RAM, and is a storage region for temporarily holding information during the operations of the control unit 560. The communication unit 530 is a communication interface with the network N.

The camera 540 is an imaging apparatus for imaging a region including a face of a person who makes payment such as the user U1. The camera 540 outputs the captured image to the control unit 560. The touch panel 550 includes a display apparatus (display unit) such as a screen and an input apparatus.

The control unit 560 is a processor, that is, a control apparatus that controls each configuration of the payment terminal 51. The control unit 560 reads the program 511 from the storage unit 510 into the memory 520 and executes the program 511. In this manner, the control unit 560 implements the functions of the reception unit 561 and the payment control unit 562.

The reception unit 561 receives an input of payment target information such as a price of a product for the person who makes payment will make a payment for. For example, the reception unit 561 receives, as payment target information, information read by a scanner (not illustrated) from a barcode on the product by a shop staff (for example, the facility staff U21) of the second commercial facility 41. Then, the reception unit 561 displays the received payment target information on the touch panel 550.

The payment control unit 562 reads code information of the privilege information displayed on the user terminal 100 from the image captured by the camera 540, analyzes the image, and extracts the privilege ID. Then, the payment control unit 562 controls the camera 540, images the face of the person who makes payment, and acquires the captured face image. Then, the payment control unit 562 transmits a face authentication payment request including the face image, payment target information, the privilege ID, and the terminal information 512 stored in the storage unit 510 to the privilege information issuing apparatus 300. Then, the payment control unit 562 receives a payment completion notification or the like, and displays the payment completion notification or the like on the touch panel 550.

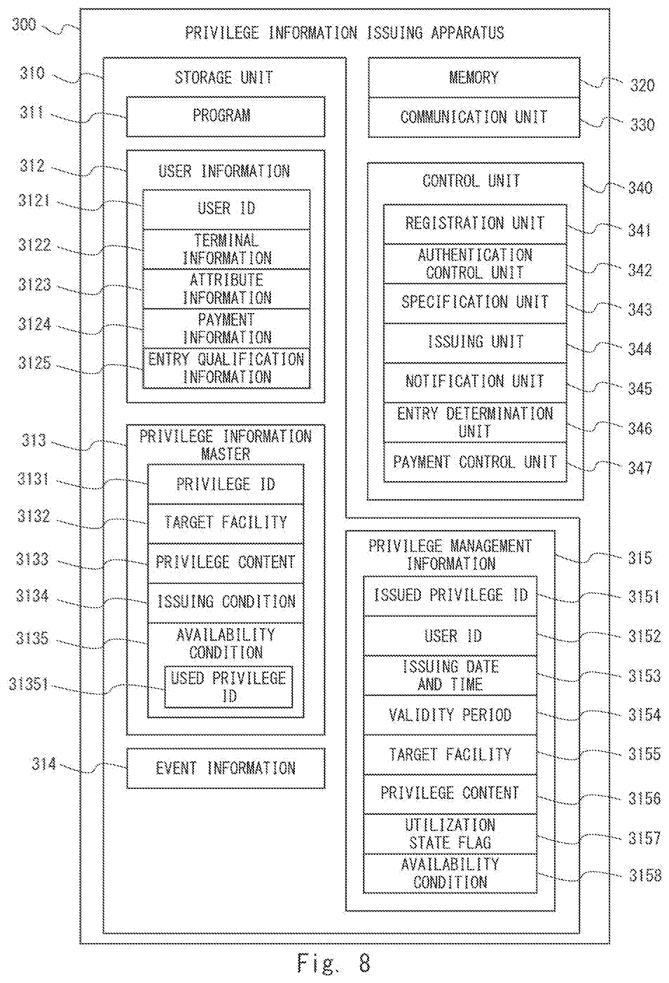

FIG. 8 is a block diagram illustrating a configuration of the privilege information issuing apparatus 300 according to the second example embodiment. The privilege information issuing apparatus 300 is an example of the aforementioned privilege information issuing apparatus 1. The privilege information issuing apparatus 300 is an information processing apparatus that assists mutual sending of customers between (the first commercial facility 403 inside) the event venue 40 and the surrounding second commercial facility 41 and the like. The privilege information issuing apparatus 300 may be made redundant across a plurality of serves, and each functional block may be implemented by a plurality of computers.

The privilege information issuing apparatus 300 includes a storage unit 310, a memory 320, a communication unit 330, and a control unit 340. The storage unit 310 is an example of a nonvolatile storage device such as a hard disk or a flash memory. The storage unit 310 stores a program 311, user information 312, a privilege information master 313, event information 314, and privilege management information 315. Note that the storage unit 310 and the face information DB 210 of the authentication apparatus 200 may be collectively regarded as a storage unit. The program 311 is a computer program (privilege information issuing program) in which registration processing of privilege information, user information, and entry qualification information, privilege information issuing processing including target specification processing, payment processing including privilege information utilization processing, and the like according to the second example embodiment are mounted.

The user information 312 is information for managing users in the area 4. Note that “users in area 4” are, for example, purchasers of the entry qualification information of the event venue 40, entry scheduled persons who are scheduled to enter the event venue 40, entering persons, and persons exiting the event venue 40. The user information 312 is information in which a user ID 3121, terminal information 3122, attribute information 3123, payment information 3124, and entry qualification information 3125 are associated.

The user ID 3121 is identification information of the user. The user ID 3121 is information that is the same as or uniquely corresponds to the user ID 211 managed in association with the face feature information 212 in the face information DB 210 of the authentication apparatus 200. Therefore, it is possible to state that the user information 312 is information associated with the identity authentication information for registration of the user via the user ID 3121. The terminal information 3122 is information corresponding to the terminal information 112 of the user terminal 100 described above.

Examples of the attribute information 3123 include, but are not limited to, a name, a date of birth, a sex, an address, a contact (a telephone number, an e-mail address, account information of a social networking service (SNS)), a member rank, information indicating a hobby, preference, or interest, a support target of an athlete or a team, and the like. Note that the member rank may be, for example, information indicating a rank or the like in members who have made payment in the event venue 40, a rank in another member service, or the like.

The payment information 3124 is credit card information, electronic money, barcode payment account information, bank withdrawal account information, or the like, and is also information used for payment using face authentication (face authentication payment).

The entry qualification information 3125 is paid digital entry ticket information for a predetermined event held in the event venue 40 on a date and time of the event. The entry qualification information 3125 may include, for example, an event ID, seat information (a seat position and a seat grade), a ticket price, and the like. Furthermore, the entry qualification information 3125 may include identification information of the event venue, an entry time zone, an event content, and the like, instead of the event ID. Also, it is possible to state that the entry qualification information 3125 according to the present example embodiment is proof information indicating that the user has the qualification of permission to enter the event venue 40 on the basis of success in the face authentication.

The privilege information master 313 is information for managing master information of the privilege information input by facility staff or the area staff. The privilege information master 313 is information in which the privilege ID 3131, a target facility 3132, privilege content 3133, an issuing condition 3134, and the availability condition 3135 are associated. The privilege ID 3131 is identification information of privilege information. The target facility 3132 is information indicating a facility where the privilege information can be used. The target facility 3132 is, for example, information indicating any one of the first commercial facility 403 and the second commercial facilities 41 to 4n. Note that the target facility 3132 may target at two or more facilities. For example, the target facility 3132 may target at two or more first commercial facilities 403 inside the event venue 40. Alternatively, the target facility 3132 may target at two or more facilities among the second commercial facilities 41 to 4n.

The privilege content 3133 is information indicating a product or a service that the user can enjoy by being used in the facility. Examples of the privilege content 3133 include, but are not limited to, discount information indicating a discount price or a discount rate, a discount target product or service, a free product or service, and the like.

The issuing condition 3134 is information indicating a condition for issuing the privilege information. Examples of the issuing condition 3134 include event information (an event ID, date and time, and the like) to be issued, the fact that entry qualification information of the event information has already been purchased, and an issuing timing. The issuing timing may be an issuing start date and time, an issuable period, for example, a period (predetermined period) defining the number of days before the date on which the target event is held, and the like. In addition, examples of the issuing condition 3134 include, but are not limited to, attribute information of the user as a target of issuing, a seat grade, a ticket price, a priority order of attribute information prioritizing issuance, and the like.

The availability condition 3135 is information indicating a condition under which the corresponding privilege information (the second privilege information, the second coupon) becomes available. The availability condition 3135 includes a used privilege ID 31351. The used privilege ID 31351 is a privilege ID of first privilege information that needs to be used in a consumption action (payment) in the first facility as a premise for making the second privilege information available.

The event information 314 is information defining an event held at the event venue 40. The event information 314 includes, for example, an event ID, a venue, event hour information, event contents, seat information (a seat type, a seat number, and arrangement), a price of the entry qualification information (ticket price), and the like. Note that examples of the event hour information include, but are not limited to, an event period, a start date and time, a scheduled start time, a scheduled end time, an entry time zone, an entry start time, and the like.

The privilege management information 315 is information for managing the privilege information issued for the user. The privilege management information 315 is information in which an issued privilege ID 3151, a user ID 3152, an issuing date and time 3153, a validity period 3154, a target facility 3155, privilege content 3156, a utilization state flag 3157, and an availability condition 3158 are associated.

The issued privilege ID 3151 is the privilege ID 3131 issued for the user corresponding to the user ID 3152. The user ID 3152 is the user ID 3121 for which the privilege information has been issued. Therefore, the privilege management information 315 is, for example, information uniquely specified by a set of the issued privilege ID 3151 and the user ID 3152. The issuing date and time 3153 is a date and time on which the privilege information has been issued. The validity period 3154 is a validity period of the privilege information. In a case where the corresponding privilege information can be used immediately after issuance, a date and time of an effective period may be set as the validity period 3154. Alternatively, the validity period 3154 may be defined by a start date and time and an end date and time (effective period) of the validity period in a case where the corresponding privilege information becomes available after elapse of a certain period after being issued. The target facility 3155 is a facility where the privilege information can be used, and is the target facility 3132 associated with the privilege ID 3131 corresponding to the issued privilege ID 3151. In principle, the privilege content 3156 is the privilege content 3133 associated with the privilege ID 3131 corresponding to the issued privilege ID 3151. However, in the case of the second privilege information, content dynamically determined if the availability condition is satisfied may be registered as the privilege content 3156. The utilization state flag 3157 is information indicating which of “available”, “not available”, and “used” the used state of the issued privilege information is. In principle, the availability condition 3158 is a used privilege ID 31351 associated with the privilege ID 3131 corresponding to the issued privilege ID 3151. However, in the case of the second privilege information, a first privilege ID dynamically determined at the time of issuing the privilege information may be registered as the availability condition 3158.

The memory 320 is a volatile storage device such as a RAM, and is a storage region for temporarily holding information during the operations of the control unit 340. The communication unit 330 is a communication interface with the network N.

The control unit 340 is a processor, that is, a control apparatus that controls each configuration of the privilege information issuing apparatus 300. The control unit 340 reads the program 311 from the storage unit 310 into the memory 320 and executes the program 311. Therefore, the control unit 340 implements functions of a registration unit 341, an authentication control unit 342, a specification unit 343, an issuing unit 344, a notification unit 345, an entry determination unit 346, and a payment control unit 347. Note that the authentication control unit 342, the specification unit 343, and the issuing unit 344 are examples of the issuing unit 11 described above. In addition, the specification unit 343 and the notification unit 345 are examples of the notification unit 12 described above.

The registration unit 341 performs registration processing and the like of the privilege information, the user information, and the entry qualification information. Specifically, the registration unit 341 receives a registration request of individual privilege information, a combination of a plurality of pieces of privilege information, availability conditions, and the like from the management terminal 60 or the like, and registers the registration request in the privilege information master 313. At this time, the registration unit 341 issues a privilege ID for the new privilege information. Furthermore, the registration unit 341 receives a registration request of the user information from the user terminal 100 or the like, and registers the registration request in the user information 312. At this time, the registration unit 341 registers face feature information based on a face image for a new user in the authentication apparatus 200, and acquires a user ID issued at the time of the registration. Then, the registration unit 341 registers the acquired user ID 3121 and the information included in the registration request in an associated manner as the user information 312 in the storage unit 310. The registration unit 341 registers, in the storage unit 310, identity authentication information for registration of the user and terminal information possessed by the user in association with each other. The registration unit 341 according to the present example embodiment registers, in the storage unit 310, the user ID 3121 uniquely corresponding to the face feature information for registration of the user, the terminal information 3122, the attribute information 3123, and the payment information 3124 as the user information 312. Furthermore, the registration unit 341 receives a registration request including the face image and the entry qualification information, associates the entry qualification information 3125 with the user information 312 specified by the face authentication based on the face image, and updates the user information 312.

The authentication control unit 342 controls identity authentication of the user using the authentication apparatus 200. In particular, the authentication control unit 342 according to the present example embodiment controls biometric authentication of the user using biometric information extracted from an image obtained by imaging the user. Specifically, the authentication control unit 342 controls the face authentication of the user using the face feature information extracted from the face image of the user. In other words, in a case where the authentication control unit 342 receives the identity authentication information for authentication of the user and the entry qualification information, the authentication control unit controls the identity authentication with reference to the storage unit 310 and the face information DB 210 of the authentication apparatus 200 using the identity authentication information for authentication. Also, in a case where the authentication control unit 342 receives an entry determination request from the entry control terminal 401, the authentication control unit 342 transmits a face authentication request including the face image included in the entry determination request to the authentication apparatus 200, receives a face authentication result from the authentication apparatus 200, and outputs the face authentication result to the entry determination unit 346. Also, in a case where the authentication control unit 342 receives a face authentication payment request from the payment terminal 51 or the like, the authentication control unit 342 transmits a face authentication request including the face image included in the face authentication payment request to the authentication apparatus 200, receives a face authentication result from the authentication apparatus 200, and outputs the face authentication result to the payment control unit 347. Note that the authentication control unit 342 may control the identity authentication other than the biometric authentication.

The specification unit 343 specifies the terminal information, the attribute information, the payment information, the entry qualification information, and the privilege information of the user on the basis of the identity authentication for the user. Specifically, in a case where the face authentication by the authentication control unit 342 is successful, the specification unit 343 specifies the terminal information 3122, the attribute information 3123, the payment information 3124, and the entry qualification information 3125 associated with the user ID 3121 of the user who has succeeded in the face authentication from the user information 312. In addition, the specification unit 343 specifies a list of privilege information associated with the user ID 3152 of the user who has succeeded in the face authentication from the privilege management information 315 in response to a privilege information inquiry request. Furthermore, the specification unit 343 specifies the issued privilege ID 3151 included in the face authentication payment request, and specifies the privilege information associated with the user ID 3152 of the user who has succeeded in the face authentication and the issued privilege ID 3151 from the privilege management information 315.

The issuing unit 344 issues a set of the first privilege information and the second privilege information for the user, the entry qualification information of which has been registered. A At this time, the second privilege information in which, as an availability condition, the privilege ID of the first privilege information has been set as a used privilege ID is selected. Furthermore, the first facility that is a target facility of the first privilege information is any one of the first commercial facility 403, the second commercial facility 41, and the like. Also, the second facility that is a target facility of the second privilege information is a second facility that is different from the first facility out of the first commercial facility 403, the second commercial facility 41 and the like. Note that the issuing unit 344 issues the utilization state flag of the first privilege information as “available” and issues the utilization state flag of the second privilege information as “not available”.

In addition, in a case where the user has carried out a consumption action using the first privilege information in the first facility, the issuing unit 344 updates the second privilege information which is a set with the used first privilege information to be available. Furthermore, in a case where the user has carried out the consumption action using the first privilege information in the first facility, the issuing unit 344 may determine privilege content of the second privilege information in accordance with the paid price in the consumption action. Note that the availability conditions may be various conditions as will be described later. Therefore, in a case where the user's consumption action using the first privilege information in the first facility satisfies the availability condition set in the second privilege information which is a set with the first privilege information, the issuing unit 344 updates the second privilege information to be available.

Furthermore, it is only necessary for the issuing unit 344 to select privilege information that satisfies the issuing condition on the basis of the attribute information associated with the user in advance from among a plurality of pieces of first privilege information that can be used in the first facility and issue the selected privilege information as the first privilege information.

Also, it is only necessary for the issuing unit 344 to issue the first privilege information and the second privilege information in a case where the authentication control unit 342 has succeeded in the identity authentication.

The notification unit 345 notifies the user terminal of the user who is the target of issuing of the set of the first privilege information and the second privilege information and the availability condition set in the second privilege information. Furthermore, the notification unit 345 notifies the user terminal of the fact that the second privilege information has become available. Furthermore, the notification unit 345 may further notify the user terminal of the determined privilege content of the second privilege information. The notification unit 345 notifies the user terminal of terminal information associated with the identity authentication information of successful identity authentication, as a destination.

The entry determination unit 346 determines whether or not the face authentication result based on the entry determination request received from the entry control terminal 401 indicates that the face authentication has been successful, and transmits the entry determination result to the entry control terminal 401. In a case where the user is a user who has succeeded in the face authentication and has registered entry qualification information, the entry determination unit 346 includes permission of entry in the entry determination result. On the other hand, in a case where the face authentication has been failed, or in a case where the user does not have a registered entry qualification information although the face authentication has been successful, the entry determination unit 346 includes non-permission of entry in the entry determination result.

The payment control unit 347 determines whether the face authentication result based on the face authentication payment request received from the payment terminal 51 or the like indicates success in the face authentication, and controls payment processing in a case where the face authentication is successful. In particular, in a case where the privilege ID is included in the face authentication payment request, the payment control unit 347 determines whether or not the privilege information corresponding to the privilege ID can be used, and in a case where the privilege information can be used, the payment control unit 347 performs payment processing using the privilege information.

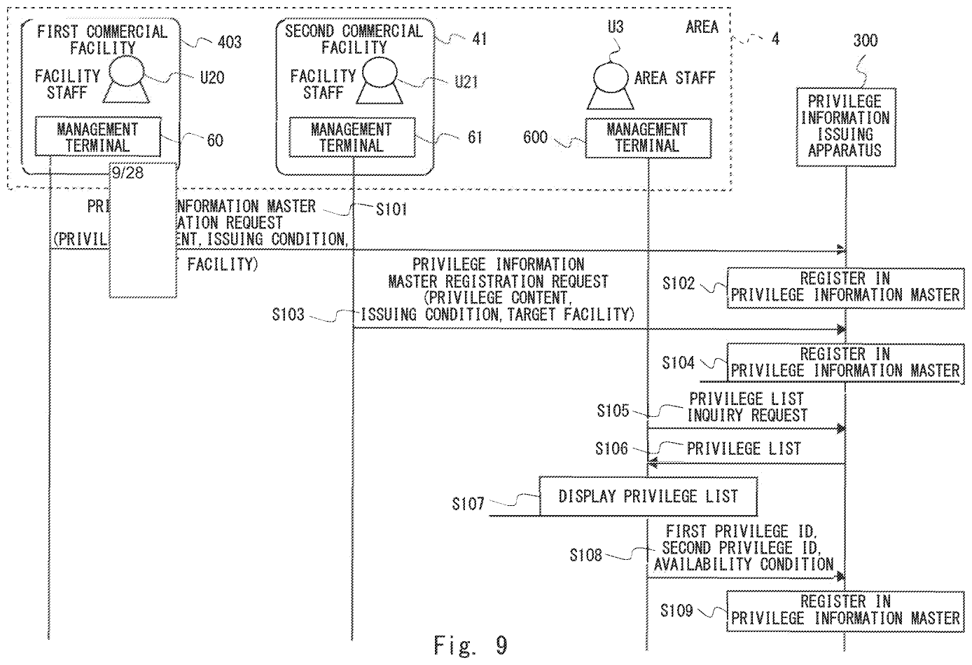

FIG. 9 is a sequence diagram illustrating a flow of privilege information registration processing according to the second example embodiment. Here, an example in which the facility staff U20 registers privilege information of the first commercial facility 403, the facility staff U21 registers the privilege information of the second commercial facility 41, and the area staff U3 registers the combination (availability condition) of the privilege information will be described. However, the registration order of the facility staff U20 and U21 may be changed. In addition, any one of the facility staff U20 and U21 may set the combination (availability condition) of privilege information.

First, the management terminal 60 receives inputs of privilege content, issuing conditions, and target facilities available in the first commercial facility 403 from the facility staff U20. The issuing conditions include event information that is a target of issuing. Also, the target facility is the first commercial facility 403. Then, the management terminal 60 transmits a privilege information master registration request including the received privilege content, issuing conditions, and target facility to the privilege information issuing apparatus 300 via the network N (S101). In response to the request, the privilege information issuing apparatus 300 issues a privilege ID corresponding to the privilege content included in the received privilege information master registration request, and registers the issued privilege ID 3131, the target facility 3132 included in the request, the privilege content 3133, and the issuing condition 3134 in association with each other as the privilege information master 313 in the storage unit 310 (S102).

Also, the management terminal 61 receives inputs of privilege content, issuing conditions, and target facilities available in the second commercial facility 41 from the facility staff U21. The issuing conditions include information regarding events held on the same day and the like in Step S101. Also, the target facility is the payment terminal 51. Then, the management terminal 61 transmits the privilege information master registration request to the privilege information issuing apparatus 300 via the network N similarly to Step S101 (S103). In response to the transmission, the privilege information issuing apparatus 300 issues a privilege ID and registers the privilege information master 313 in the storage unit 310 similarly to Step S102 (S104).

Then, the management terminal 600 transmits a privilege list inquiry request to the privilege information issuing apparatus 300 via the network N in response to an operation of the area staff U3 (S105). Then, the privilege information issuing apparatus 300 acquires a list of privilege information (privilege list) from the privilege information master 313 in response to the received privilege list inquiry request, and returns the privilege list to the management terminal 600 (S106). Then, the management terminal 600 displays the received privilege list (S107). At this time, it is assumed that the privilege list includes the privilege information registered in Steps S102 and S104. In response to the display, the management terminal 600 receives a set of the first privilege ID and the second privilege ID and the availability condition from the area staff U3. For example, the management terminal 600 may receive the first privilege ID as privilege information of the first commercial facility 403, the second privilege ID as privilege information of the second commercial facility 41, and the availability condition as the first privilege ID (utilization of the privilege information in the first commercial facility 403). Alternatively, the management terminal 600 may receive the first privilege ID as privilege information of the second commercial facility 41, the second privilege ID as privilege information of the first commercial facility 403, and the availability condition as the first privilege ID (utilization of the privilege information in the second commercial facility 41). Then, the management terminal 600 transmits the received first privilege ID, second privilege ID, and availability condition to the privilege information issuing apparatus 300 via the network N (S108). In response to the transmission, the privilege information issuing apparatus 300 registers the first privilege ID in the used privilege ID 31351 of the availability condition 3135 associated with the privilege ID 3131 corresponding to the received second privilege ID and updates the privilege information master 313 (S109).

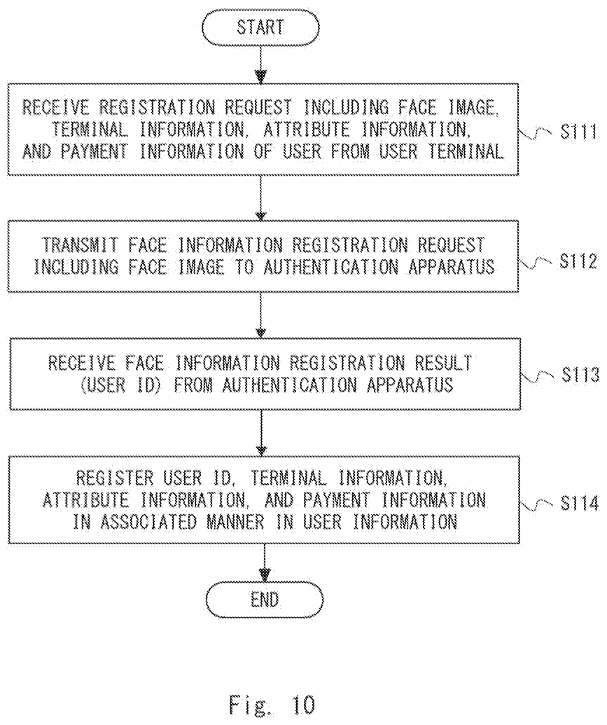

FIG. 10 is a flowchart illustrating a flow of user information registration processing according to the second example embodiment. First, the privilege information issuing apparatus 300 receives a registration request including a face image, terminal information, attribute information, and payment information of the user U1 from the user terminal 100 via the network N (S111). Then, the privilege information issuing apparatus 300 transmits a face information registration request including the face image to the authentication apparatus 200 via the network N (S112). In response to the transmission, the authentication apparatus 200 performs face information registration processing.

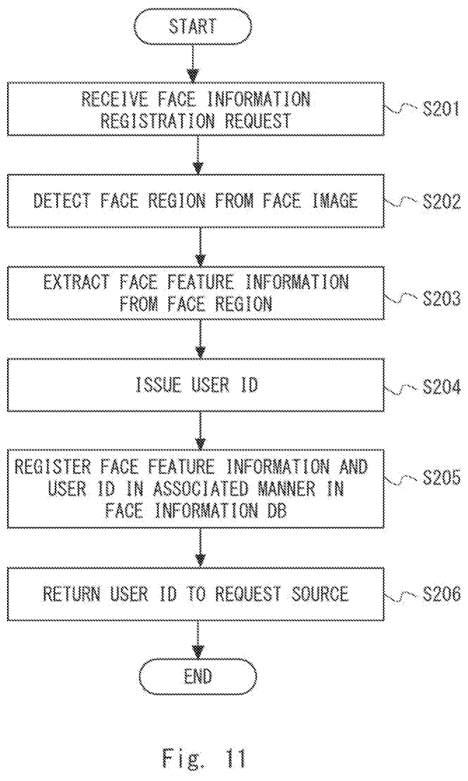

FIG. 11 is a flowchart illustrating a flow of face information registration processing performed by the authentication apparatus according to the second example embodiment. First, the authentication apparatus 200 receives the face information registration request (S201). For example, the authentication apparatus 200 receives the face information registration request from the privilege information issuing apparatus 300 via the network N. Then, the face detection unit 220 detects a face region from the face image included in the face information registration request (S202). Then, the feature point extraction unit 230 extracts feature points (face feature information) from the face region detected in Step S202 (S203). Then, the registration unit 240 issues the user ID 211 (S204). Then, the registration unit 240 registers the extracted face feature information 212 and the issued user ID 211 in an associated manner in the face information DB 210 (S205). Thereafter, the registration unit 240 returns the issued user ID 211 to the request source (for example, the privilege information issuing apparatus 300) (S206). Note that the authentication apparatus 200 may perform the face information registration processing in response to the face information registration request received from any information registration terminal. For example, the information registration terminal is an information processing apparatus, such as a personal computer, a smartphone, or a tablet terminal.

Returning to FIG. 10, the description will be continued.

The privilege information issuing apparatus 300 receives a face information registration result (user ID) from the authentication apparatus 200 via the network N (S113). Then, the privilege information issuing apparatus 300 registers the received user ID 3121 and the terminal information 3122, the attribute information 3123, and the payment information 3124 received in Step S101 in an associated manner in the user information 312 (S114).

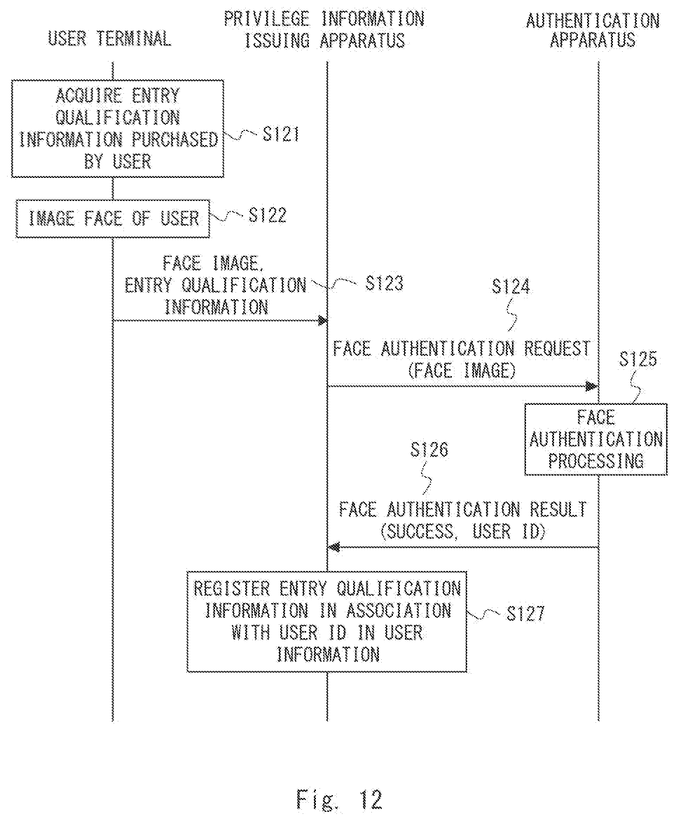

FIG. 12 is a sequence diagram illustrating a flow of entry qualification information registration processing according to the second example embodiment. As a premise, it is assumed that the user U1 has registered the user information in the privilege information issuing apparatus 300 and has purchased entry qualification information of an event held on a predetermined date at the event venue 40. At this time, the user terminal 100 acquires the entry qualification information purchased by the user U1 (S121). For example, the user terminal 100 may receive an input of identification information or the like of the entry qualification information from the user U1. Alternatively, the user terminal 100 may acquire information regarding the entry qualification information provided through a notification from a purchasing site of the entry qualification information. Then, the user terminal 100 images the face of the user U1 (S122). Then, the user terminal 100 transmits a registration request including the face image and the entry qualification information to the privilege information issuing apparatus 300 via the network N (S123).

Then, the privilege information issuing apparatus 300 transmits a face authentication request including the received face image to the authentication apparatus 200 via the network N (S124). In response to the transmission, the authentication apparatus 200 performs face authentication processing (S125).

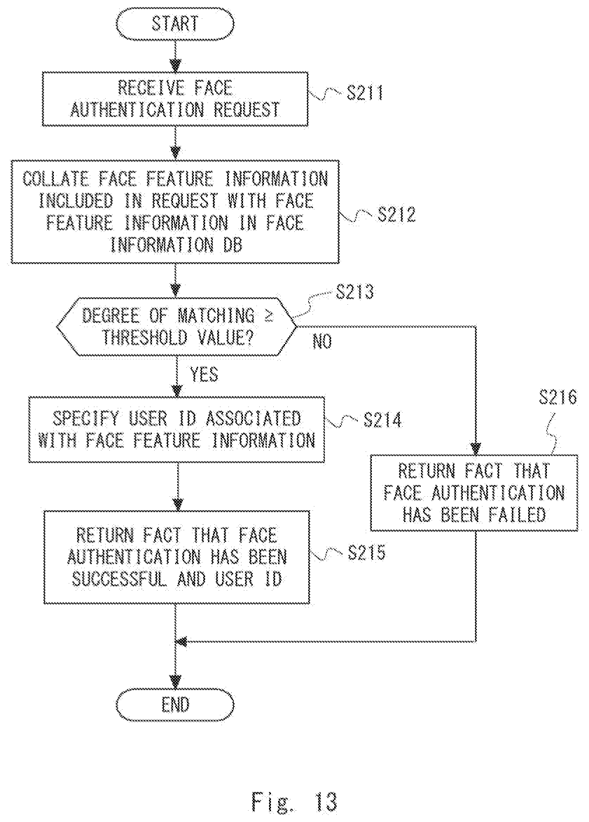

FIG. 13 is a flowchart illustrating a flow of face authentication processing performed by the authentication apparatus 200 according to the second example embodiment. First, the authentication apparatus 200 receives a face authentication request from the privilege information issuing apparatus 300 via the network N (S211). Then, the authentication apparatus 200 extracts face feature information from the face image included in the face authentication request similarly to Steps S202 and S203 described above. Then, the authentication unit 250 of the authentication apparatus 200 collates the face feature information extracted from the face image included in the face authentication request with the face feature information 212 of the face information DB 210 (S212), and calculates a degree of matching. Then, the authentication unit 250 determines whether or not the degree of matching is equal to or greater than a threshold value (S213). In a case where the pieces of face feature information match each other, that is, in a case where the degree of matching between the pieces of face feature information is equal to or greater than the threshold value, the authentication unit 250 specifies the user ID 211 associated with the face feature information 212 (S214). Then, the authentication unit 250 returns a face authentication result, which includes information indicating that the face authentication has been successful and the specified user ID 211, to the privilege information issuing apparatus 300 via the network N (S215). In a case where the degree of matching is less than the threshold value in Step S213, the authentication unit 250 returns the face authentication result including information indicating that the face authentication has been failed to the privilege information issuing apparatus 300 via the network N (S216).

Returning to FIG. 12, the description will be continued.

The privilege information issuing apparatus 300 receives the face authentication result from the authentication apparatus 200 via the network N (S126). Then, the privilege information issuing apparatus 300 determines whether or not the face authentication has been successful. Specifically, the privilege information issuing apparatus 300 refers to the face authentication result and determines that the face authentication has been successful if the face authentication result includes the user ID. Note that in a case where it is determined that the face authentication has been failed, the privilege information issuing apparatus 300 may return the fact that the user has failed the face authentication to the user terminal 100 via the network N.

In a case where the face authentication has been successful, the privilege information issuing apparatus 300 associates the entry qualification information 3125 received in Step S123 with the user ID 3121 included in the face authentication result and registers them in the user information 312 (S127).

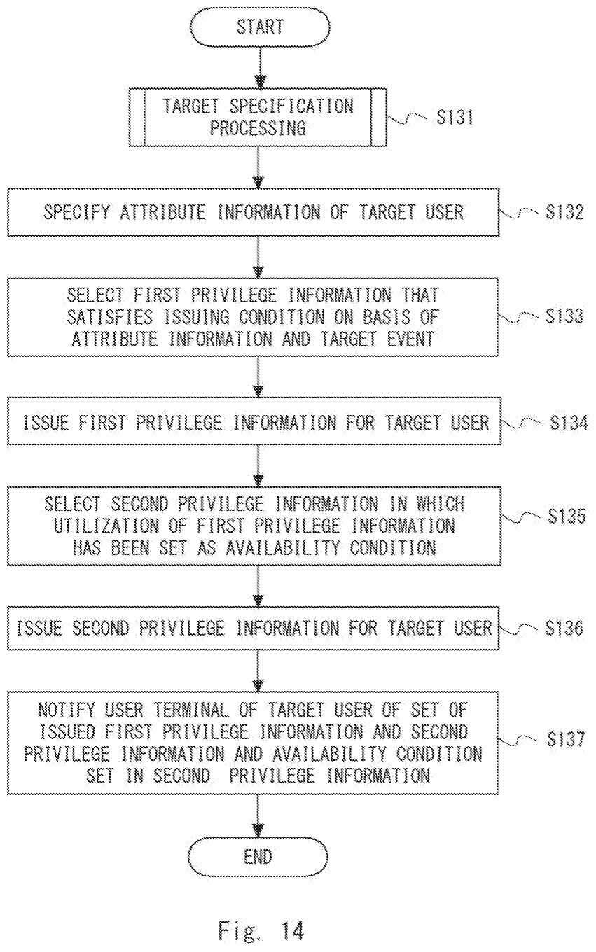

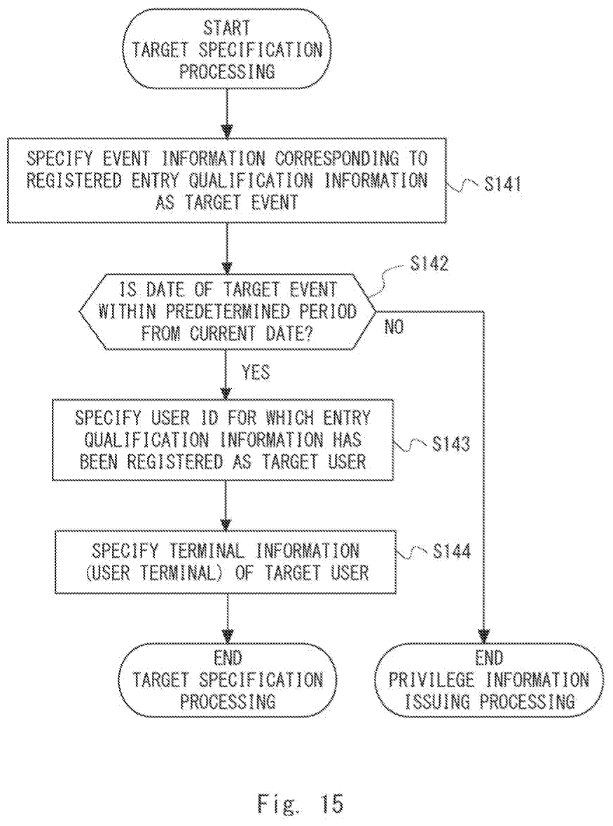

FIG. 14 is a flowchart illustrating a flow of privilege information issuing processing according to the second example embodiment. First, the privilege information issuing apparatus 300 performs target specification processing (S131). Here, the target specification processing is processing of specifying a target user (user information, a user ID) and a target event (event information, an event ID) of the privilege information issuing processing. Although Examples 2-1 to 2-3 in FIGS. 15 to 17 will be described below as the target specification processing, the target specification processing is not limited thereto. As a premise, the privilege information issuing apparatus 300 targets at the user who has already purchased the entry qualification information of the target event as a target user.

FIG. 15 is a flowchart illustrating a flow of target specification processing in Example 2-1 according to the second example embodiment. Example 2-1 is executed continuously after the entry qualification information registration processing in FIG. 12 described above. First, the privilege information issuing apparatus 300 specifies event information corresponding to the registered entry qualification information as a target event after Step S127 in FIG. 12 (S141). Next, the privilege information issuing apparatus 300 determines whether or not the date of the target event is within a predetermined period from the current date (S142). In a case where the date of the event is within the predetermined period from the current date, the privilege information issuing apparatus 300 specifies the user ID in which the entry qualification information has been registered as the target user (S143). Then, the privilege information issuing apparatus 300 specifies the terminal information (user terminal) of the target user (S144). Specifically, the privilege information issuing apparatus 300 specifies the terminal information 3122 associated with the user ID 3121 of the target user from the user information 312. Then, the processing proceeds to Step S132 in FIG. 14. On the other hand, in a case where the date of the event is not within the predetermined period from the current date in Step S142, the privilege information issuing apparatus 300 ends the privilege information issuing processing.

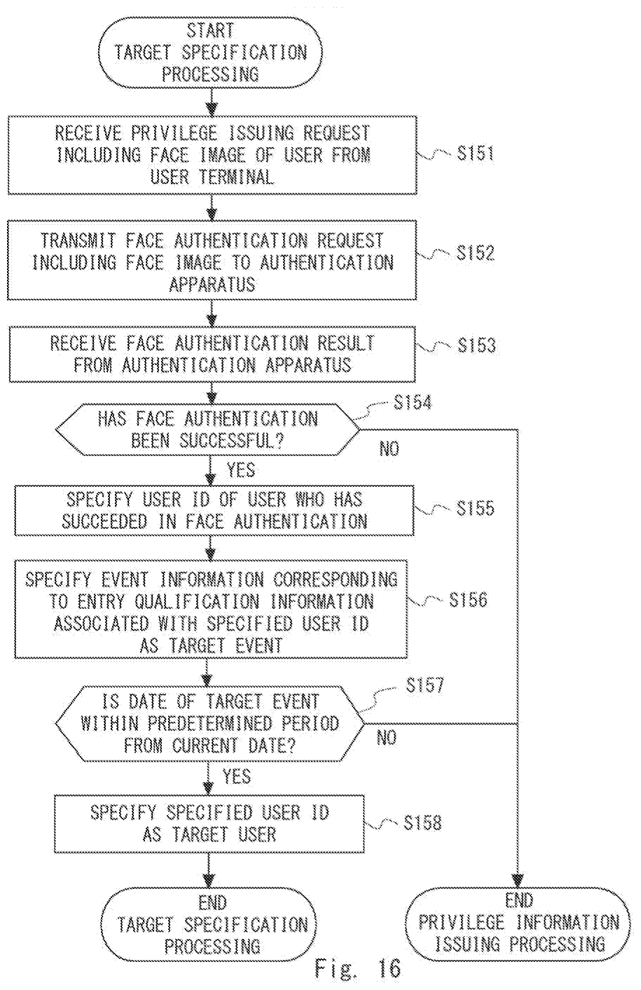

FIG. 16 is a flowchart illustrating a flow of target specification processing in Example 2-2 according to the second example embodiment. Example 2-2 is a case where the user U1 after registering the user information and the entry qualification information makes a privilege issuing request. In this case, the user terminal 100 images the face of the user U1 in response to an instruction of the privilege issuing request from the user U1, and transmits the privilege issuing request including the face image to the privilege information issuing apparatus 300 via the network N.

In response to the transmission, the privilege information issuing apparatus 300 receives the privilege issuing request including the face image of the user from the user terminal 100 via the network N (S151). Then, the privilege information issuing apparatus 300 transmits a face authentication request including the face image to the authentication apparatus 200 via the network N (S152). In response to the transmission, the authentication apparatus 200 performs face authentication processing similarly to FIG. 13 described above. Then, the privilege information issuing apparatus 300 receives a face authentication result from the authentication apparatus 200 (S153). Then, the privilege information issuing apparatus 300 determines whether or not the face authentication has been successful (S154).

In a case where the face authentication has been successful, the privilege information issuing apparatus 300 specifies the user ID of the user who has succeeded in the face authentication (S155). Specifically, the privilege information issuing apparatus 300 acquires the user ID from the received face authentication result. Then, the privilege information issuing apparatus 300 specifies event information corresponding to the entry qualification information associated with the specified user ID as a target event (S156). Next, the privilege information issuing apparatus 300 determines whether or not the date of the target event is within a predetermined period from the current date (S157). In a case where the date of the event is within the predetermined period from the current date, the privilege information issuing apparatus 300 specifies the specified user ID as a target user (S158). Then, the processing proceeds to Step S132 in FIG. 14. On the other hand, in a case where the face authentication has been failed in Step S154, or in a case where the date of the event is not within the predetermined period from the current date in Step S157, the privilege information issuing apparatus 300 ends the privilege information issuing processing.

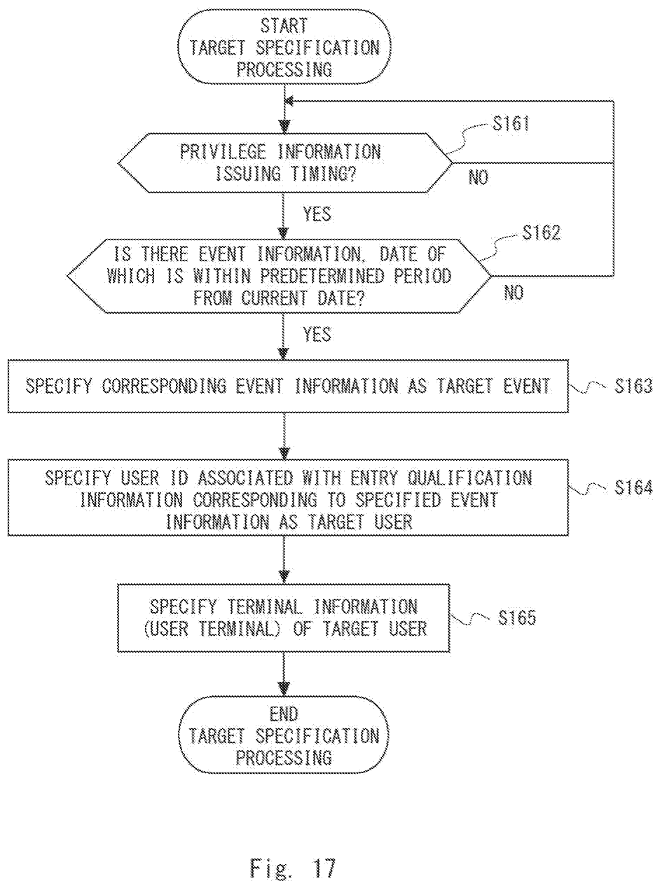

FIG. 17 is a flowchart illustrating a flow of target specification processing in Example 2-3 according to the second example embodiment. Example 2-3 is a case where the privilege information issuing apparatus 300 starts execution of the target specification processing at an arbitrary timing after the user information and the entry qualification information are registered.

First, the privilege information issuing apparatus 300 determines whether or not a privilege information issuing timing has come (S161). For example, in a case where the execution of the privilege information issuing processing is periodically registered in a schedule, the privilege information issuing apparatus 300 determines that the privilege information issuing timing has come in the case of the scheduled date.

Next, the privilege information issuing apparatus 300 determines whether or not information regarding an event, the date of which is within the predetermined period from the current date, is present (S162). Note that in a case where the privilege information issuing timing has not come in Step S161 or in a case where there is no information regarding an event within the predetermined period, Step S161 is executed again after elapse of a specific time.

In a case where information regarding an event within the predetermined period is present in Step S162, the privilege information issuing apparatus 300 specifies the corresponding event information as a target event (S163). Then, the privilege information issuing apparatus 300 specifies the user ID associated with the entry qualification information corresponding to the specified event information as a target user (S164). Then, the privilege information issuing apparatus 300 specifies the terminal information (user terminal) of the target user (S165). Then, the processing proceeds to Step S132 in FIG. 14.

Returning to FIG. 14, the description will be continued. Subsequently, the privilege information issuing apparatus 300 specifies attribute information of the target user (S132). Then, the privilege information issuing apparatus 300 selects the first privilege information satisfying the issuing condition on the basis of the attribute information and the target event (S133). Specifically, the privilege information issuing apparatus 300 narrows down the privilege ID 3131 for which the specified attribute information and target event are defined in the issuing condition 3134 from the privilege information master 313. For example, in a case where a degree of matching of the user's age, sex, member rank, hobby, and the like indicated by the attribute information is equal to or greater than a threshold value, it may be determined that the issuing condition is satisfied. In a case where the current date is within a predetermined period before the date of the target event, it may be determined that the issuing condition is satisfied. Furthermore, the privilege information issuing apparatus 300 may select the first privilege information that satisfies the issuing condition on the basis of the entry qualification information purchased by the target user. For example, in a case where a seat grade is equal to or higher than a predetermined level and a total purchase price, an average price, or the like of a ticket price purchased this time or tickets purchased in the past exceeds a threshold value, it may be determined that the issuing condition is satisfied. Note that the privilege information issuing apparatus 300 may select the first privilege information by regarding any one of the event venue 40, the second commercial facility 41, and the like as the target facility (first facility).

Then, the privilege information issuing apparatus 300 issues the selected first privilege information for the target user (S134). Specifically, the privilege information issuing apparatus 300 generates the privilege management information 315 by associating the privilege ID 3131, the target facility 3132, and the privilege content 3133 of the selected first privilege information as the issued privilege ID 3151, the target facility 3155, and the privilege content 3156. In addition, the privilege information issuing apparatus 300 sets a target user to the user ID 3152, the current date and time to the issuing date and time 3153, and the validity period 3154 on the basis of the issuing condition 3134 for the generated privilege management information 315. In addition, the privilege information issuing apparatus 300 sets “available” in the utilization state flag 3157 for the generated privilege management information 315. The privilege information issuing apparatus 300 registers the generated and set privilege management information 315 in the storage unit 310.

Subsequently, the privilege information issuing apparatus 300 selects the second privilege information in which utilization of the first privilege information has been set as the availability condition (S135). Specifically, the privilege information issuing apparatus 300 selects, as the second privilege information, one in which the privilege ID 3131 of the first privilege information has been set in the used privilege ID 31351 from the privilege information master 313. Furthermore, the privilege information issuing apparatus 300 may narrow down the privilege information in which the second facility different from the target facility 3132 of the first privilege information has been set as the target facility 3132, and then select the second privilege information. For example, in a case where the target facility of the first privilege information is the first commercial facility 403, the privilege information issuing apparatus 300 narrows down the privilege information to one, the target facility 3132 of which is any of the second commercial facilities 41 to 4n. Also, in a case where the target facility of the first privilege information is any one of the second commercial facilities 41 to 4n, the privilege information issuing apparatus 300 narrows down the privilege information to one, the target facility 3132 of which is the first commercial facility 403. In this manner, the selection target is narrowed down, and processing efficiency can be improved.

Then, the privilege information issuing apparatus 300 issues the selected second privilege information for the target user (S136). Specifically, the privilege information issuing apparatus 300 generates the privilege management information 315 by associating the privilege ID 3131, the target facility 3132, and the privilege content 3133 of the selected second privilege information as the issued privilege ID 3151, the target facility 3155, and the privilege content 3156. In addition, the privilege information issuing apparatus 300 sets a target user to the user ID 3152, and the current date and time to the issuing date and time 3153 for the generated privilege management information 315. In addition, the privilege information issuing apparatus 300 sets “available” in the utilization state flag 3157 and sets the first privilege ID in the availability condition 3158 for the generated privilege management information 315. The privilege information issuing apparatus 300 registers the generated and set privilege management information 315 in the storage unit 310.

Thereafter, the privilege information issuing apparatus 300 notifies the user terminal of the target user of the set of the issued first privilege information and second privilege information and the availability condition set in the second privilege information (S137). In response to the notification, the user terminal 100 displays the notified set of the first privilege information and the second privilege information and availability condition.

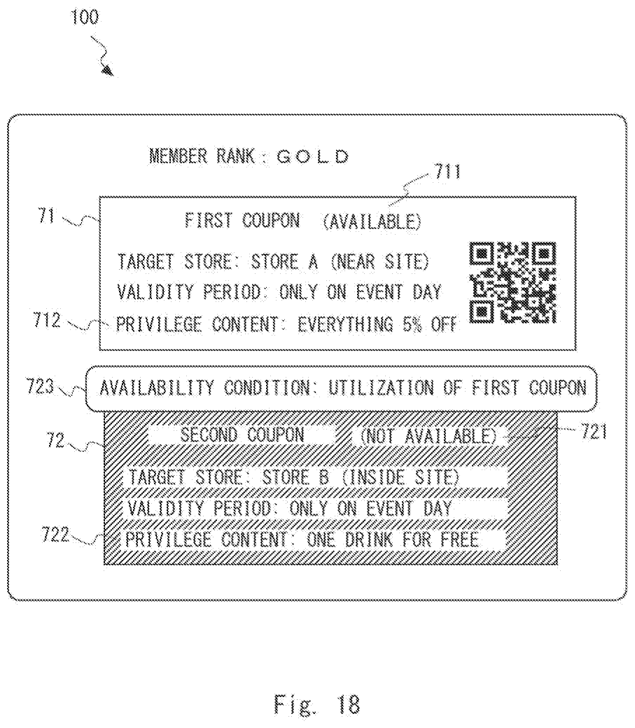

FIG. 18 is a diagram illustrating Display Example 2-1 of a set of privilege information on the user terminal 100 according to the second example embodiment. Here, the first coupon 71 is an example of the first privilege information, the second coupon 72 is an example of the second privilege information, and each of the first coupon 71 and the second coupon 72 is an electronic coupon. The first coupon 71 indicates that a utilization state flag 711 is “available” and privilege content 712 is available only on the event day at the store A (the second commercial facility 41 or the like) near the event venue 40. Although the privilege content 712 indicates “everything 5% off” in the store A, for example, the privilege content 712 is not limited thereto. The first coupon 71 may use, as a utilization condition, a consumption action with a payment price of a predetermined price or more.

The second coupon 72 indicates that a utilization state flag 721 is “not available” and privilege content 722 is available only on the event day at the store B (the first commercial facility 403) inside the event venue 40. Although the privilege content 722 indicates “one drink free” in the store B, for example, the privilege content 722 is not limited thereto. Further, the second coupon 72 indicates that an availability condition 723 is the utilization of the first coupon 71.

Therefore, it is possible to state that the second coupon 72 is a coupon that can be exchanged with one drink for free at the store B inside the event venue 40 in a case where the coupon offering everything 5% off for payment of equal to or greater than XX yen is used at the store A (surrounding facility) on the event (sport game) day, for example.

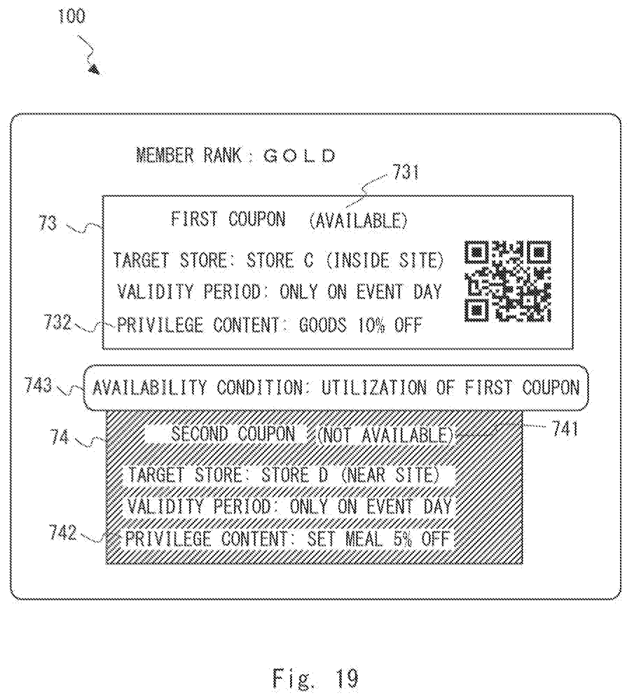

FIG. 19 is a diagram illustrating Display Example 2-2 of a set of privilege information on the user terminal 100 according to the second example embodiment. Here, a first coupon 73 is an example of the first privilege information, a second coupon 74 is an example of the second privilege information, and each of the first coupon 73 and the second coupon 74 is an electronic coupon. The first coupon 73 indicates that a utilization state flag 731 is “available” and privilege content 732 is available only on the event day at the store C (the first commercial facility 403) inside the event venue 40. Although the privilege content 732 indicates “goods 10% off” in the store C, for example, the privilege content 732 is not limited thereto. The first coupon 73 may use, as a utilization condition, a consumption action with a payment price of a predetermined price or more.

The second coupon 74 indicates that a utilization state flag 741 is “not available” and privilege content 742 is available only on the event day at the store D (the second commercial facility 4n or the like) near the event venue 40. Although the privilege content 742 indicates “set meal 5% off” in the store D, for example, the privilege content 742 is not limited thereto. Further, the second coupon 74 indicates that an availability condition 743 is the utilization of the first coupon 73.

Therefore, it is possible to state that the second coupon 74 is a coupon that can offer a set meal 5% off at the store D (surrounding store) in a case where the coupon offering 10% off for payment of equal to or greater than XX yen for goods is used at the store C inside the event venue 40 on the event (sport game) day, for example.

Note that the processing may be executed as follows instead of the user terminal 100 imaging the face of the user, every time before Step S122 in FIG. 12 described above or the target specification processing in Example 2-2 in FIG. 16. For example, in a case where the face image used at the time of registration of the user information is stored in the storage unit 110, the user terminal 100 may read the face image instead of Step S122. Alternatively, in a case where the user ID issued at the time of registration of the user information is stored in the storage unit 110, the user terminal 100 may read the user ID and transmit a registration request including the user ID and the entry qualification information to the privilege information issuing apparatus 300 via the network N instead of Step S122. In this case, the privilege information issuing apparatus 300 may omit the face authentication processing.

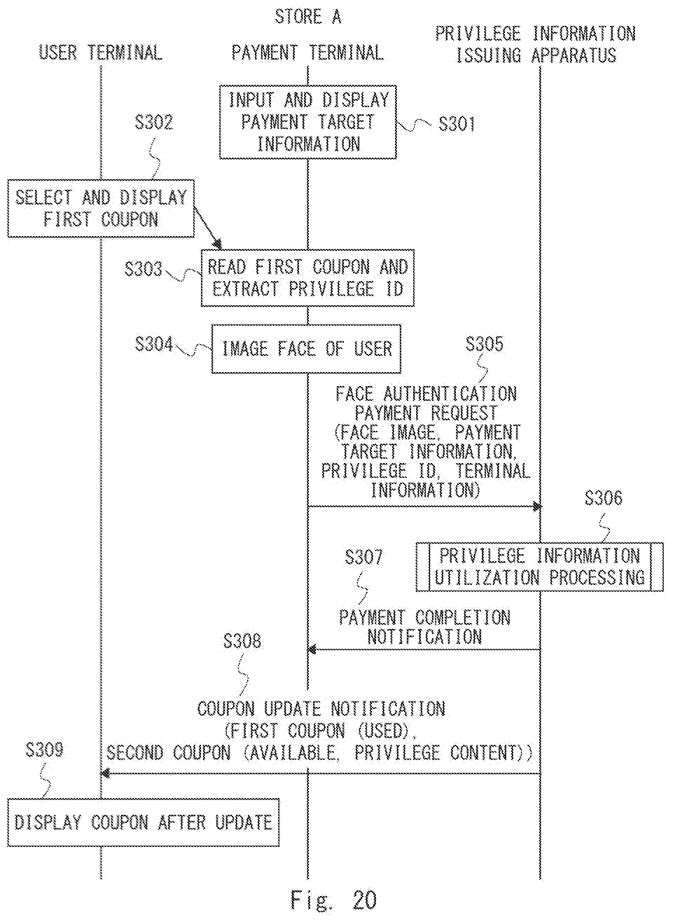

FIG. 20 is a sequence diagram illustrating a flow of first privilege information utilization processing performed by the user according to the second example embodiment. Here, it is assumed that a set of the first coupon and the second coupon has been issued for the user U1. Also, it is assumed that the user U1 uses the first coupon at a time of making a payment at the store A described above.

First, the user U1 decides a product to be purchased at the store A, and goes to the payment terminal 51 for payment. Then, the payment terminal 51 inputs and displays payment target information through scanning or the like of the product to be purchased and the touch panel 550 (S301). In response to the input and the display, the user terminal 100 performs display of Display Example 2-1 of FIG. 18 described above, receives an operation of selecting the first coupon 71 from the user U1, and displays the first coupon 71 in a selected state (S302). Then, the user U1 holds code information of the first coupon 71 displayed on the user terminal 100 over the camera 540 of the payment terminal 51. In response to the action, the payment terminal 51 reads the first coupon and extracts the privilege ID (S303). Specifically, the payment terminal 51 images the code information of the first coupon 71 with the camera 540, analyzes the captured image, and extracts the image as the privilege ID. Then, the camera 540 of the payment terminal 51 images the face of the user U1 (S304).

In response to the imaging, the payment terminal 51 transmits a face authentication payment request including the face image of the user U1, the payment target information, the privilege ID, and the terminal information 512 to the privilege information issuing apparatus 300 via the network N (S305). Then, the privilege information issuing apparatus 300 performs privilege information utilization processing (S306).

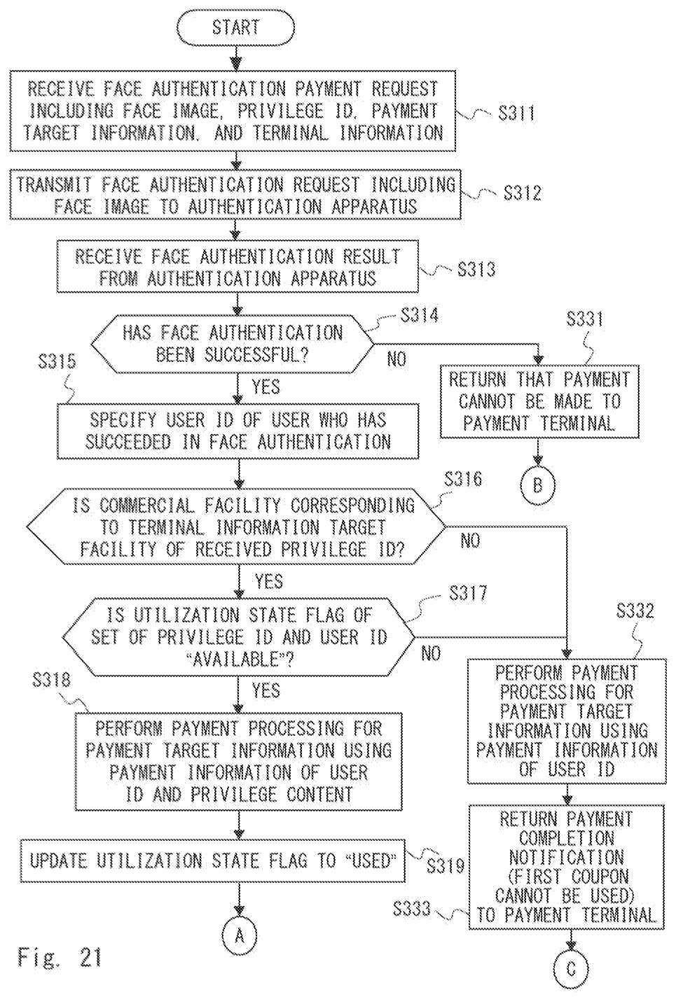

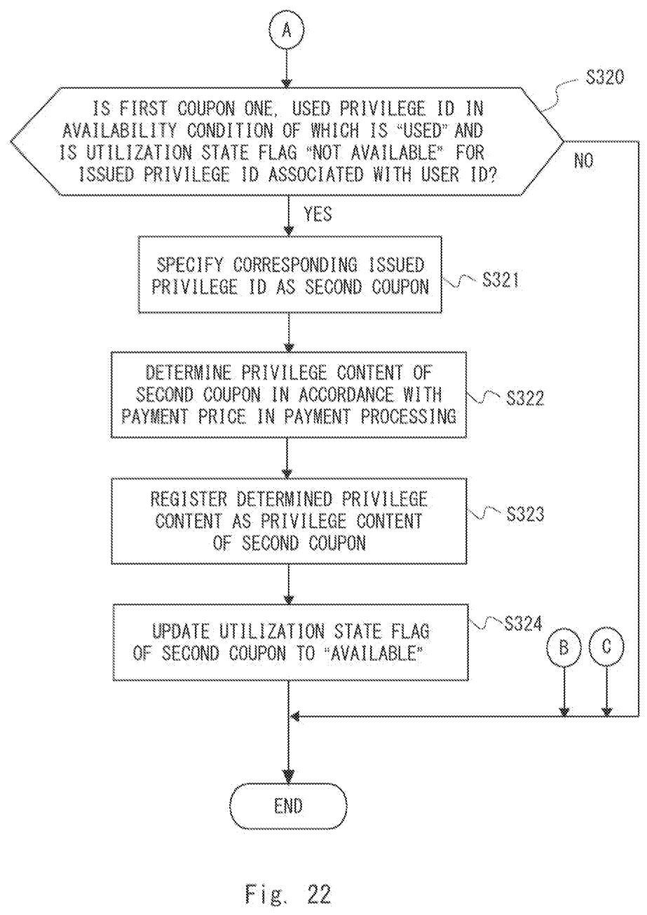

FIGS. 21 and 22 are flowcharts illustrating a flow of privilege information utilization processing according to the second example embodiment. First, the privilege information issuing apparatus 300 receives a face authentication payment request including a face image, a privilege ID, payment target information, and terminal information from the payment terminal 51 via the network N (S311). Then, the privilege information issuing apparatus 300 transmits a face authentication request including the face image to the authentication apparatus 200 via the network N (S312). In response to the transmission, the authentication apparatus 200 performs face authentication processing similarly to FIG. 13 described above. Then, the privilege information issuing apparatus 300 receives a face authentication result from the authentication apparatus 200 (S313). Then, the privilege information issuing apparatus 300 determines whether or not the face authentication has been successful (S314).

In a case where the face authentication has been successful, the privilege information issuing apparatus 300 specifies the user ID of the user who has succeeded in the face authentication (S315). Then, the privilege information issuing apparatus 300 determines whether or not the commercial facility corresponding to the terminal information is a target facility of the received privilege ID (S316). Specifically, the privilege information issuing apparatus 300 specifies the commercial facility from the terminal information included in the face authentication payment request. Furthermore, the privilege information issuing apparatus 300 specifies the target facility 3155 associated with the set of the privilege ID (issued privilege ID 3151) included in the face authentication payment request and the specified user ID 3152 from the privilege management information 315. Then, the privilege information issuing apparatus 300 determines whether or not the specified commercial facility is the specified target facility 3155. In a case where the commercial facility is the target facility in Step S316, the privilege information issuing apparatus 300 determines whether or not the utilization state flag 3157 of the set of the privilege ID 3151 included in the face authentication payment request and the specified user ID 3152 is “available” (S317).

In a case where the utilization state flag 3157 is “available”, the privilege information issuing apparatus 300 performs payment processing in regard to the payment target information using the payment information and the privilege content of the user ID (S318). Specifically, the privilege information issuing apparatus 300 specifies the payment information 3124 associated with the specified user ID 3121 from the user information 312. Furthermore, the privilege information issuing apparatus 300 specifies the privilege content 3156 associated with the set of the issued privilege ID 3151 and the specified user ID 3152 from the privilege management information 315. Then, the privilege information issuing apparatus 300 calculates a payment price by applying the specified privilege content 3156 to the price of the payment target information included in the face authentication payment request. For example, in a case where the privilege content 3156 is “everything 5% off”, the privilege information issuing apparatus 300 calculates a price obtained by discounting 5% from the price of the payment target information as a payment price. Then, the privilege information issuing apparatus 300 transmits an instruction to withdraw the payment amount to a payment server (not illustrated) using the specified payment information 3124 and receives a payment result. Note that the payment server is a known server operated by a financial institution or the like and illustration and detailed description thereof will thus be omitted.

Then, the privilege information issuing apparatus 300 updates the utilization state flag of the used privilege information to “used” (S319). Specifically, the privilege information issuing apparatus 300 updates the utilization state flag 3157 associated with the set of the issued privilege ID 3151 and the specified user ID 3152 to “used” from the privilege management information 315.

Subsequently, the privilege information issuing apparatus 300 determines whether or not the first coupon is a first coupon, the used privilege ID of the availability condition of which is “used”, and whether or not the utilization state flag is “not available” for the issued privilege ID associated with the user ID (S320). Specifically, the privilege information issuing apparatus 300 searches for the issued privilege ID associated with the specified user ID 3152 from the privilege management information 315. Then, the privilege information issuing apparatus 300 determines whether or not the first coupon is the first coupon, the used privilege ID of the availability condition 3158 of which is “used” for the searched issued privilege ID. In addition, the privilege information issuing apparatus 300 determines whether or not the utilization state flag 3157 of the searched issued privilege ID is “not available”. In a case where the used privilege ID is “used” and the utilization state flag is “not available” in Step S320, the privilege information issuing apparatus 300 specifies the corresponding issued privilege ID 3151 as the second coupon (S321).

Then, the privilege information issuing apparatus 300 determines privilege content of the second coupon in accordance with the payment price in the payment processing (S322). For example, in a case where the payment price is equal to or greater than a specific price, a discount rate or a discount price of the privilege content of the second coupon may be increased. Then, the privilege information issuing apparatus 300 registers the determined privilege content as privilege content of the second coupon (S323). Note that Steps S322 and S323 are not essential.

Then, the privilege information issuing apparatus 300 updates the utilization state flag of the second coupon to “available” (S324). Specifically, the privilege information issuing apparatus 300 updates the utilization state flag 3157 associated with the set of the issued privilege ID 3151 of the second coupon and the specified user ID 3152 to “available” from the privilege management information 315. After Step S324, the processing proceeds to Step S307 in FIG. 20.

Note that in a case where the used privilege ID is not “used” in Step S320 or in a case where the utilization state flag is not “not available”, the privilege information utilization processing is ended.

In addition, in a case where the face authentication is failed in Step S314, the privilege information issuing apparatus 300 returns the fact that the payment cannot be made to the payment terminal 51 (S331). Furthermore, in a case where the commercial facility is not the target facility in Step S316, or in a case where the utilization state flag 3157 is not “available”, that is, the utilization state flag 3157 is “not available” or “used” in Step S317, the privilege information issuing apparatus 300 performs the payment processing without using the privilege information. In other words, the privilege information issuing apparatus 300 performs payment processing in regard to the payment target information using the payment information of the specified user ID (S332). The method of the payment processing is similar to that in Step S318 described above. Thereafter, the privilege information issuing apparatus 300 returns a payment completion notification including the fact that the first coupon is not available to the payment terminal 51 (S333). After Steps S331 and S333, the privilege information utilization processing is ended.

Returning to FIG. 20, the description will be continued. After Step S324, the privilege information issuing apparatus 300 returns the payment completion notification to the payment terminal 51 via the network N (S307). At this time, the payment terminal 51 may display the payment completion notification on the touch panel 550. Also, the privilege information issuing apparatus 300 transmits a coupon update notification to the user terminal 100 via the network N (S308). Here, the coupon update notification includes the fact that the availability flag of the first coupon 71 is “used” and the availability flag of the second coupon 72 is “available”, and the privilege content of the second coupon 72. In response to the transmission, the user terminal 100 displays the received coupon update notification (S309).

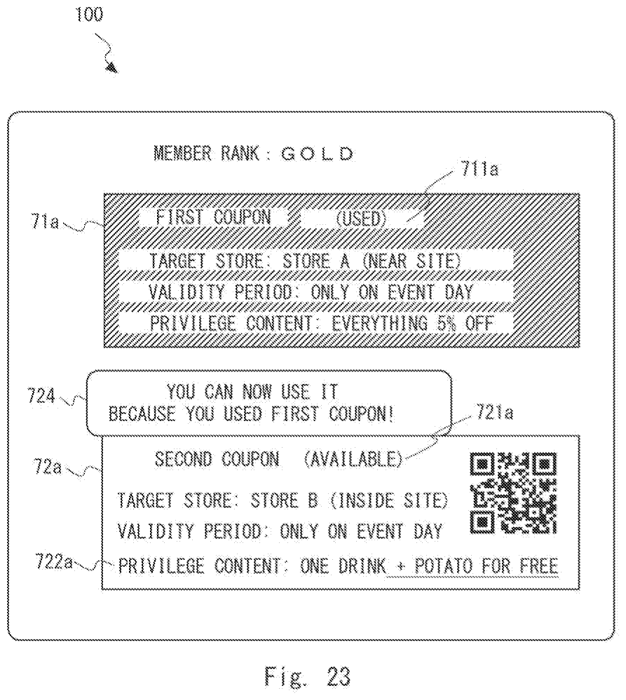

FIG. 23 is a diagram illustrating a display example of a privilege information availability notification on the user terminal 100 according to the second example embodiment. FIG. 23 illustrates a display example after the first coupon 71 is selected and used and paid at the store A in Display Example 2-1 in FIG. 18 described above. A first coupon 71a indicates that a utilization state flag 711a of the first coupon 71 has been updated to “used”. On the other hand, a second coupon 72a indicates that a utilization state flag 721a of the second coupon 72 is “available” and “potato for free” has been added to privilege content 722a. Furthermore, an update notification message 724 indicates that, for example, “you can now use it because you used the first coupon!”. In this manner, the user U1 can easily recognize that the second coupon 72a has become available due to the consumption action using the first coupon 71 in the store A.

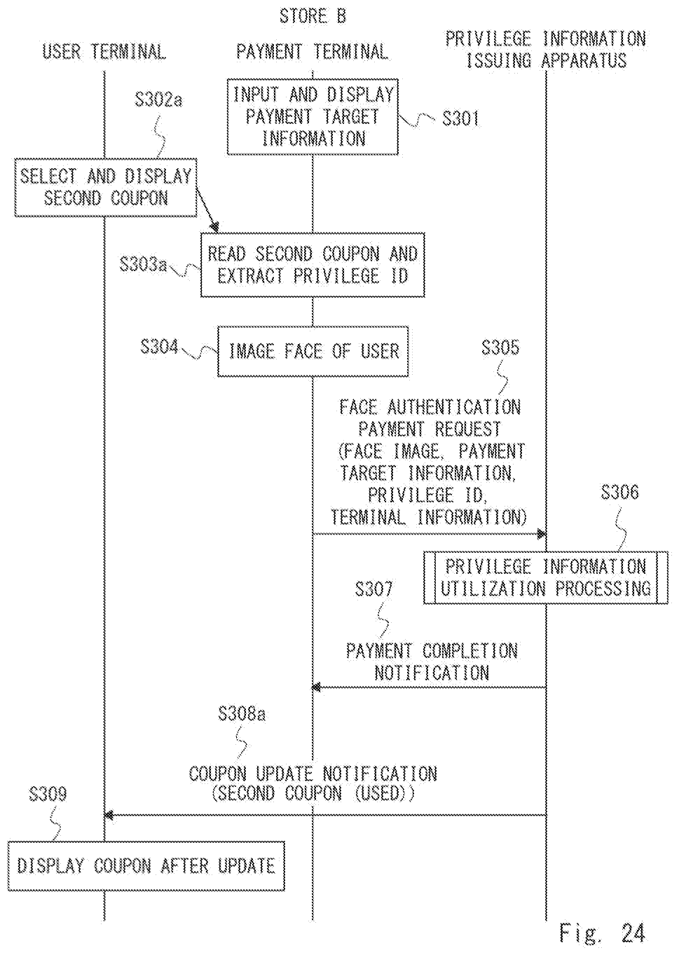

FIG. 24 is a sequence diagram illustrating a flow of second privilege information utilization processing performed by the user according to the second example embodiment. Here, it is assumed that a set of the first coupon and the second coupon has been issued for the user U1 and the user U1 has made a payment using the first coupon at the store A described above. Therefore, it is assumed that the first coupon has been used and the second coupon can be used.

First, the user U1 decides food and drink to be purchased at the store B (the first commercial facility 403) and goes to the payment terminal 50 for payment. Then, the payment terminal 50 inputs and displays the payment target information (S301). In response to the input and the display, the user terminal 100 displays the display example in FIG. 23 described above, receives an operation of selecting the second coupon 72a from the user U1, and displays the second coupon 72a in a selected state (S302a). Then, the user U1 holds code information of the second coupon 72a displayed on the user terminal 100 over the camera 540 of the payment terminal 50. In response to the action, the payment terminal 50 reads the second coupon and extracts the privilege ID (S303a). Subsequently, Steps S304 to S306 in FIG. 20 described above are executed. In this example, since the privilege content 3156 is “one drink+potato for free”, the privilege information issuing apparatus 300 calculates a price obtained by subtracting the prices of the one drink and the potato from the price of the payment target information as a payment price in Step S318 in FIG. 20. Then, since there is no corresponding second coupon in Step S320 in FIG. 21, the processing is ended, and the payment completion notification in Step S307 is provided. Also, the privilege information issuing apparatus 300 transmits a coupon update notification to the user terminal 100 via the network N (S308a). Here, the coupon update notification includes that the availability flag of the second coupon 72 is “used”. In response to the transmission, the user terminal 100 displays the received coupon update notification (S309).

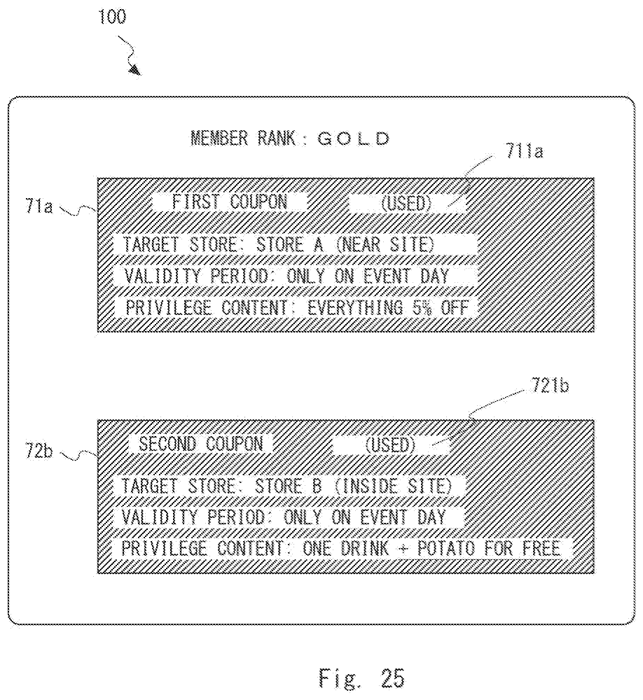

FIG. 25 is a diagram illustrating a display example after utilization of privilege information on the user terminal according to the second example embodiment. FIG. 25 illustrates a display example after the second coupon 72a is selected and used and paid at the store B in the display example in FIG. 23 described above. A second coupon 72b indicates that a utilization state flag 721b of the second coupon 72a has been updated to “used”.

As described above, a set of privilege information obtained by linking privilege information that can be used in a commercial facility in an event venue with privilege information that can be used in a commercial facility in the neighborhood of the event venue is issued in the present embodiment. In other words, a plurality of pieces of privilege information that can be used in different facilities are issued as a set. In particular, in a case where a consumption action using the first privilege information has been carried out in one first facility, the second privilege information to be used in the other second facility becomes available. The user is notified of this point at the time of issuing of the set of privilege information, that is, in a stage in which the first privilege information can be used and the second privilege information cannot be used. Therefore, the user is more strongly motivated by the fact that the user can enjoy not only the privilege of the first privilege information but also the privilege of the second privilege information with the condition of utilization of the first privilege information, in regard to the consumption action in the first facility. Therefore, it is possible to assist collaboration such as mutual sending of customers between facilities that issue the coupons inside the area including the event venue.

### Third Example Embodiment

A third example embodiment is a modified example of the second example embodiment described above. A specification unit and an issuing unit according to the third example embodiment determine priority of a notification on the basis of attribute information associated with a user in advance for each of a plurality of pieces of first privilege information. Then, the specification unit and the issuing unit select two or more pieces of privilege information that satisfy an issuing condition in accordance with the determined priority and issue each of the selected pieces of privilege information as first privilege information. Then, the notification unit provides a notification of the first privilege information in accordance with the priority.

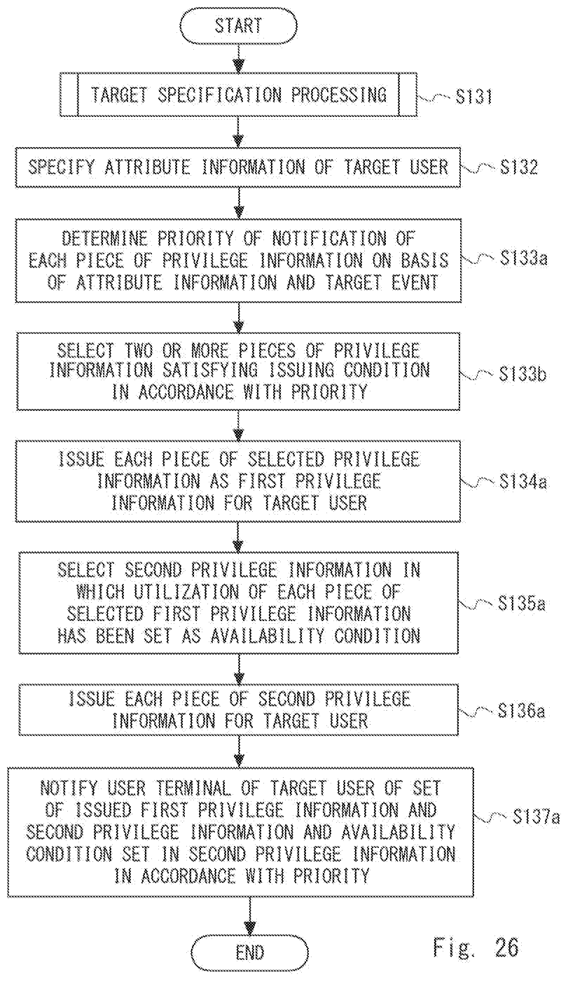

FIG. 26 is a flowchart illustrating a flow of privilege information issuing processing according to the third example embodiment. Steps S131 and S132 are similar to those in FIG. 14 described above. After Step S132, a privilege information issuing apparatus 300 refers to privilege management information 315 and determines priority of a notification of each piece of privilege information on the basis of attribute information of a target user and a target event (S133a). For example, it is only necessary for the privilege information issuing apparatus 300 to determine the priority of the notification for the target user on the basis of a priority order of attribute information of placing priority on a row included in an issuing condition 3134 in each piece of privilege information. For example, priority of cafe as a target facility of the privilege information may be higher than that of a bar in a case where the sex of the attribute information is a female, and a priority of the bar as the target facility of the privilege information may be higher than that of the cafe in a case where the sex of the attribute information is a male. Then, the privilege information issuing apparatus 300 selects two or more pieces of privilege information that satisfies another issuing condition in accordance with the determined priority (S133b). Then, the privilege information issuing apparatus 300 issues each piece of the selected privilege information as first privilege information for the target user (S134a).

Thereafter, the privilege information issuing apparatus 300 selects second privilege information in which utilization of each piece of first privilege information has been set as an availability condition, for each piece of the selected first privilege information (S135a). Note that the privilege information issuing apparatus 300 may also determine the priority for the second privilege information on the basis of attribute information of the target user, and select two or more pieces of second privilege information in accordance with the priority. Then, the privilege information issuing apparatus 300 issues each piece of the selected second privilege information for the target user (S136a). Thereafter, the privilege information issuing apparatus 300 notifies a user terminal of the target user of the set of the issued first privilege information and second privilege information and the availability condition set in the second privilege information in accordance with the priority (S137a).

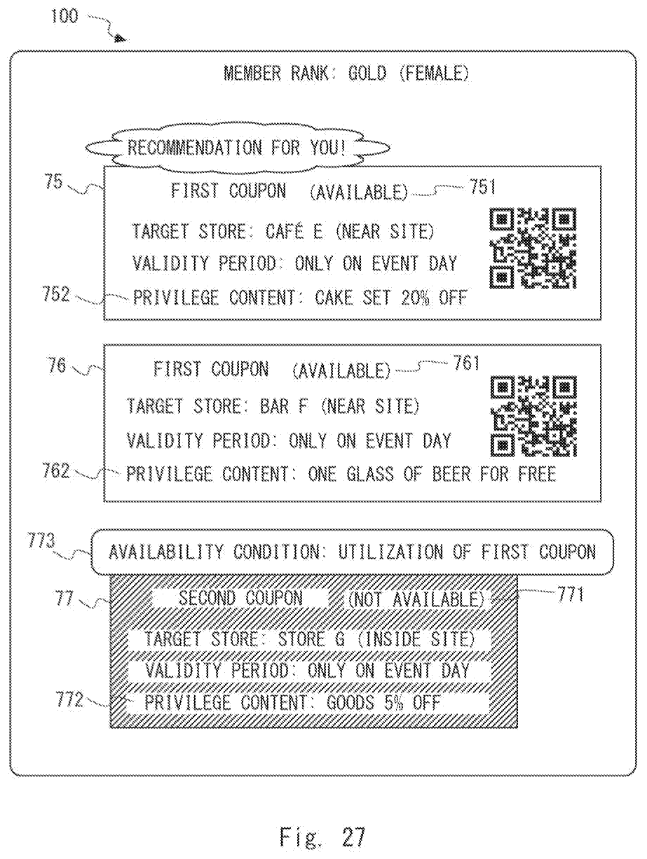

FIG. 27 is a diagram illustrating Display Example 3-1 of a set of privilege information on the user terminal 100 according to the third example embodiment. Here, a first coupon 75 indicates that a utilization state flag 751 is “available” and privilege content 752 can be used only on the event day at a cafe E near an event venue 40. Although the privilege content 752 indicates “cake set 20% off” in the cafe E, for example, the privilege content 752 is not limited thereto. Also, a first coupon 76 indicates that a utilization state flag 761 is “available” and privilege content 762 can be used only on the event day at a bar F near an event venue 40. Although the privilege content 762 indicates “one glass of beer for free” in the bar F, for example, the privilege content 762 is not limited thereto. A second coupon 77 indicates that a utilization state flag 771 is “not available” and privilege content 772 is available only on the event day at the store G inside the event venue 40. Although the privilege content 772 indicates “goods 5% off” in the store G for example, the privilege content 772 is not limited thereto. Furthermore, an availability condition 773 of the second coupon 72 is “utilization of the first coupon”, and indicates that the second coupon 72 can be used by using any one of the first coupons 75 and 76. In particular, the example of FIG. 27 illustrates that the first coupon 75 of the cafe E is displayed in a higher priority order than the first coupon 76 of the bar F in the case where the target user is a female.

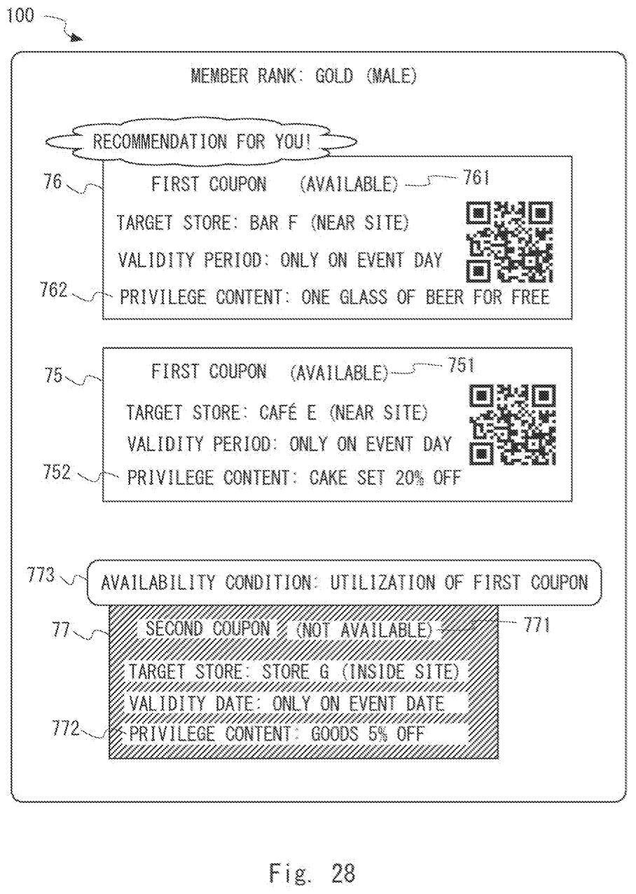

FIG. 28 is a diagram illustrating Display Example 3-2 of a set of privilege information on the user terminal 100 according to the third example embodiment. As compared with the aforementioned example in FIG. 27, FIG. 28 illustrates that the first coupon 76 of the bar F is displayed with a higher priority order than the first coupon 75 of the cafe E in the case where the target user is a male.

In this manner, according to the third example embodiment, the set of privilege information matching preference of the user is preferentially displayed, and a utilization rate of the privilege information can thus be improved.

Note that the specification unit and the issuing unit may select and issue a set of first privilege information and second privilege information that satisfy the issuing condition on the basis of attribute information associated with the user in advance from among a plurality of pieces of first privilege information that can be used in the first facility and a plurality of pieces of second privilege information that can be used in the second facility. In other words, the set of coupons may be dynamically determined for each user. For example, the privilege information issuing apparatus 300 may dynamically determine a set of coupons using an artificial intelligence (AI) model. In other words, the AI model may use, as inputs, the target event, the attribute information of the target user, the plurality of pieces of first privilege information, and the plurality of pieces of second privilege information in which the availability conditions have been set, and may use, as outputs, a set of the first privilege information and the second privilege information. It is assumed that the AI model has learned sets of input data and output data as teacher data. In this manner, it is possible to present various sets of privilege information matching the needs while finely responding to diversification of the needs of users, and to thereby further improve the utilization rate of the privilege information.

### Other Example Embodiments

Note that the aforementioned example embodiments have been described on the assumption that the identity authentication is based on the face authentication, the present disclosure is not limited thereto. In addition, although the description has been made on the assumption that the payment processing is based on the face authentication payment, the present disclosure may be applied to another payment method. In addition, the identity authentication at the time of issuing the privilege information, identity authentication at the time of entering and exiting the event venue, and identity authentication at the time of utilization of the privilege information in the commercial facility inside the event venue and in the commercial facility in the neighborhood of the event venue are also not limited to the face authentication, and other identity authentication, which will be described later, may be applied.

In addition, although the aforementioned embodiments have been described on the assumption that the identity authentication (authentication for checking the identity, identity specification processing, and the like) is based on the face authentication, other biometric authentication using biometric information may also be performed. As the biometric authentication and the biometric information, other technologies using a captured image of a person can be applied. For example, as the biometric information, data (feature amount) calculated from physical characteristics unique to an individual such as a fingerprint, a voiceprint, a vein, a retina, an iris of a pupil, and a pattern (pattern) of a palm may be used. For the biometric authentication, feature information indicating the physical characteristics of a person may be extracted from the captured image of a part of the body of the user, the extracted feature information may be collated with feature information registered in advance, and the authentication may be regarded as being successful if the degree of matching is equal to or greater than the threshold value. For example, the biometric authentication may be authentication based on the appearance shape of the person. In this case, the feature information is information regarding the appearance shape of the person, for example, information indicating features such as a body shape, a height, and clothes. In addition, instead of the biometric authentication, another identity authentication may be applied, and the biometric information may also be another identity authentication information. Examples of the identity authentication information include, but are not limited to, a combination of a user ID, an ID, and a password, description contents (an identification number and the like or a password) of an identification card such as an individual number and a driver's license, an electronic certificate, code information, and the like. The code information may be a two-dimensional code, for example, a QR code (registered trademark).

Note that although the aforementioned second example embodiment has been described on the assumption that the authentication apparatus 200 and the privilege information issuing apparatus 300 are different information processing apparatuses, the authentication apparatus 200 and the privilege information issuing apparatus 300 may be the same information processing apparatus. For example, the privilege information issuing apparatus 300 may further associate and register the face feature information with the user ID 3121 of the user information 312. In this case, the control unit 340 only needs to further have the functions of the face detection unit 220, the feature point extraction unit 230, the registration unit 240, and the authentication unit 250 in FIG. 4.

Furthermore, the availability condition set in the second privilege information described above may include, for example, the following conditions.

### (1) A Total Price of Payment Prices in One or More First Facilities

The availability condition may be a case where the payment price in the consumption action using the first privilege information in the first facility is equal to or greater than a predetermined price (for example, 2000 yen or more). In this case, the payment price of the availability condition may be a payment price in one store belonging to the first facility or may be a total price of payment prices in a plurality of stores belonging to the first facility.

### (2) A Consumption Action in a Plurality of First Facilities

The availability condition may be a case where the number of stores in the first facility where the user has carried out the consumption action using the first privilege information exceeds a predetermined number or a case where the total price of the payment prices at the stores or each payment price at each store is equal to or greater than a predetermined price.

### (3) Purchase of Predetermined Product

The availability condition may be a case where a predetermined product is purchased using the first privilege information in the first facility or a case where a utilization fee is paid for a provided service. This leads to promotion of utilization of a specific product or service by the facility staff or the area staff designating the product or service, the sales and recognition of which are desired.

### (4) A Consumption Action is Face Authentication Payment

The first privilege information can become available through payment based not only on the face authentication but also on other identity authentication. However, the second privilege information may be issued as “available” in a case where the first privilege information is pad using “face authentication”. In other words, the availability condition set in the second privilege information may be a case where the consumption action using the first privilege information in the first facility is payment using “face authentication”. In this manner, the utilization of the face authentication can be promoted out of the payment using the identity authentication.

Furthermore, the combination of the first privilege information and the second privilege information may be selected by the user. For example, the privilege information issuing apparatus 300 notifies the user terminal of a list of a plurality of pieces of first privilege information and a plurality of pieces of second privilege information and causes the user terminal to display the list at the time of issuing of the privilege information. Then, the user selects a set of the first privilege information and the second privilege information from the list displayed on the user terminal. The user terminal transmits a set of a first privilege ID and a second privilege ID selected by the user to the privilege information issuing apparatus 300. The privilege information issuing apparatus 300 issues first privilege information corresponding to the received first privilege ID, and issues second privilege information in which the received first privilege ID is set in a used privilege ID in an availability condition corresponding to the received second privilege ID (issued privilege ID).

In addition, the consumption action using the first privilege information in the first facility is not limited to the face authentication payment, and may include success in identity authentication performed by an identity authentication terminal installed at a specific point in the area 4. For example, the availability condition set in the second privilege information may include entrance/exit through face authentication at a specific point, check-in by face authentication at an accommodation facility, and the like.

Note that the entry qualification information may not necessarily be registered with the condition of success in face authentication in the entry qualification information registration processing in FIG. 12 described above. Alternatively, in a case where the user ID issued at the time of registration of the user information is stored in the user terminal, the user terminal may transmit a registration request including the user ID and the entry qualification information instead of the face image to the privilege information issuing apparatus 300 in Step S123. In that case, the privilege information issuing apparatus 300 may register the user ID and the entry qualification information included in the received registration request in an associated manner in user information. Alternatively, a sales server of the entry qualification information may transmit a registration request including the user ID and the entry qualification information of the purchaser to the privilege information issuing apparatus 300 at the time of purchasing the entry qualification information, and cause the privilege information issuing apparatus 300 to register the user ID and the entry qualification information.

Note that the entry qualification information registration processing in FIG. 12 described above may be performed by an information registration terminal instead of the user terminal 100. The information registration terminal may be, for example, a KIOSK terminal installed in a station or a commercial facility. In this case, the user terminal 100 transfers the entry qualification information to the KIOSK terminal, for example. Alternatively, the user inputs the entry qualification information to the KIOSK terminal. Then, the KIOSK terminal transmits the acquired entry qualification information and a face image obtained by imaging the user with the KIOSK terminal to the privilege information issuing apparatus 300. Note that in a case where a current location is used to issue the privilege information, the position information of the KIOSK terminal may be used. In addition, it is only necessary for the privilege information issuing apparatus 300 to notify the KIOSK terminal of the issued privilege information. At this time, the KIOSK terminal may display code information or the like of the privilege information such that the code information can be visually recognized by the user, and the user terminal may acquire the privilege information by scanning the code information displayed on the screen of the KIOSK terminal. Alternatively, the KIOSK terminal may print and output the code information or the like of the received privilege information. Alternatively, the privilege information issuing apparatus 300 may provide a notification of the privilege information issued with respect to the terminal information (user terminal) of the user specified by face authentication.

Note that the aforementioned issuing unit may select privilege information in accordance with attributes of the event, and issue and present the privilege information and notify the user of the privilege information. For example, in a case where the event is a sport game, a coupon that can be used at a support goods store may be issued to guide the user to the sales store. In addition, in a case where the event is a test, a coupon that can be used in a quiet cafe may be issued to guide the user to the cafe.

Note that the validity period (available period) of the privilege information may be a predetermined period such as several hours including at least one of a time zone before a start of the event or a time zone after the start, only the date of the event, or several weeks including the date of the event.

Note that the second coupon displayed in FIGS. 18, 19, 27, 28, and the like described above may be inactive before the availability condition is satisfied, and may selectively become active in a case where the availability condition is satisfied.

In the above-described example, the program includes a group of instructions (or software code) for causing a computer to perform one or more functions described in the example embodiments if the program is read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage apparatus. The program may be transmitted on a transitory computer-readable medium or a communication medium. By way of example, and not limitation, transitory computer-readable or communication media include electrical, optical, acoustic, or other forms of propagated signals.

Note that the present disclosure is not limited to the above example embodiments, and can be appropriately changed without departing from the gist. Furthermore, the present disclosure may be implemented by appropriately combining the respective example embodiments.

Some or all of the above example embodiments may be described as the following Supplementary Notes, but are not limited to the following.

### Supplementary Note A1

A privilege information issuing apparatus including:
an issuing means for issuing, for a user who has purchased entry qualification information that enables the user to enter an event venue through identity authentication, first privilege information that is able to be used in a first facility which is any one of a first commercial facility inside the event venue and a second commercial facility in a neighborhood of the event venue and second privilege information in which an availability condition has been set, the availability condition being a condition that the second privilege information is able to be used in a second facility which is different from the first facility out of the first commercial facility and the second commercial facility by a consumption action using the first privilege information being carried out in the first facility; and
a notification means for notifying a terminal of the user of a set of the first privilege information and the second privilege information and the availability condition set in the second privilege information.

### Supplementary Note A2

The privilege information issuing apparatus according to Supplementary Note A1, in which
the issuing means updates the second privilege information to be available in a case where the user has carried out the consumption action using the first privilege information in the first facility, and
the notification means notifies the terminal of the user of a fact that the second privilege information has become available.

### Supplementary Note A3

The privilege information issuing apparatus according to Supplementary Note A2, in which
the issuing means determines privilege content of the second privilege information in accordance with a price paid in the consumption action in a case where the user has carried out the consumption action using the first privilege information in the first facility, and
the notification means further notifies the terminal of the user of the determined privilege content of the second privilege information.

### Supplementary Note A4

The privilege information issuing apparatus according to any one of Supplementary Notes A1 to A3, in which the issuing means selects privilege information that satisfies an issuing condition on the basis of attribute information associated with the user in advance from among a plurality of pieces of the first privilege information that is able to be used in the first facility, and the issuing means issues the selected privilege information as the first privilege information.

### Supplementary Note A5

The privilege information issuing apparatus according to Supplementary Note A4, in which
the issuing means determines a priority of a notification on the basis of the attribute information associated with the user in advance for each of the plurality of pieces of first privilege information, selects two or more pieces of privilege information that satisfies the issuing condition in accordance with the priority, and issues each piece of the selected privilege information as the first privilege information, and
the notification means provides a notification of the first privilege information in accordance with the priority.

### Supplementary Note A6

The privilege information issuing apparatus according to any one of Supplementary Notes A1 to A3, in which the issuing means selects and issues a set of the first privilege information and the second privilege information that satisfies an issuing condition on the basis of attribute information associated with the user in advance from among a plurality of pieces of the first privilege information that is able to be used in the first facility and a plurality of pieces of the second privilege information that is able to be used in the second facility.

### Supplementary Note A7

The privilege information issuing apparatus according to any one of Supplementary Notes A1 to A6, including:
a registration means for registering identity authentication information for registration of the user and terminal information owned by the user in an associated manner in a storage means; and
an authentication control means for referring to the storage means using identity authentication information for authentication of the user and controlling identity authentication in a case where the identity authentication information for authentication of the user and the entry qualification information are received, in which
the issuing means issues the first privilege information and the second privilege information in a case where the identity authentication has successfully been performed, and
the notification means notifies the terminal of the user as a destination of the terminal information associated with the identity authentication information with which the identity authentication has successfully been performed.

### Supplementary Note B1

A privilege information issuing system including:
a storage apparatus that stores first privilege information that is able to be used in a first facility which is any one of a first commercial facility inside an event venue and a second commercial facility in a neighborhood of the event venue and second privilege information that is able to be used in a second facility which is different from the first facility out of the first commercial facility and the second commercial facility; and
a privilege information issuing apparatus that is connected to the storage apparatus,
in which the privilege information issuing apparatus includes
an issuing means for issuing, for a user who has purchased entry qualification information that enables the user to enter the event venue through identity authentication, the first privilege information and the second privilege information in which an availability condition has been set with reference to the storage apparatus, the availability condition being a condition that the second privilege information is able to be used by a consumption action using the first privilege information being carried out in the first facility, and
a notification means for notifying a terminal of the user of a set of the first privilege information and the second privilege information and the availability condition set in the second privilege information.

### Supplementary Note B2

The privilege information issuing system according to Supplementary Note B1, in which
the issuing means updates the second privilege information to be available in a case where the user has carried out the consumption action using the first privilege information in the first facility, and
the notification means notifies the terminal of the user of a fact that the second privilege information has become available.

### Supplementary Note C1

A privilege information issuing method causing a computer to:
issue, for a user who has purchased entry qualification information that enables the user to enter an event venue through identity authentication, first privilege information that is able to be used in a first facility which is any one of a first commercial facility inside the event venue and a second commercial facility in a neighborhood of the event venue and second privilege information in which an availability condition has been set, the availability condition being a condition that the second privilege information is able to be used in a second facility which is different from the first facility out of the first commercial facility and the second commercial facility by a consumption action using the first privilege information being carried out in the first facility; and
notify a terminal of the user of a set of the first privilege information and the second privilege information and the availability condition set in the second privilege information.

### Supplementary Note D1

A non-transitory computer-readable medium that stores a privilege information issuing program that causes a computer to execute:
issuing processing of issuing, for a user who has purchased entry qualification information that enables the user to enter an event venue through identity authentication, first privilege information that is able to be used in a first facility which is any one of a first commercial facility inside the event venue and a second commercial facility in a neighborhood of the event venue and second privilege information in which an availability condition has been set, the availability condition being a condition that the second privilege information is able to be used in a second facility which is different from the first facility out of the first commercial facility and the second commercial facility by a consumption action using the first privilege information being carried out in the first facility; and
notification processing of notifying a terminal of the user of a set of the first privilege information and the second privilege information and the availability condition set in the second privilege information.

Although the present invention has been described with reference to the example embodiments (and examples), the present invention is not limited to the above example embodiments (and examples). Various modified examples that can be understood by those skilled in the art can be made to the configuration and details of the present invention within the scope of the present invention.

### REFERENCE SIGNS LIST

1 PRIVILEGE INFORMATION ISSUING APPARATUS
11 ISSUING UNIT
12 NOTIFICATION UNIT
1000 PRIVILEGE INFORMATION ISSUING SYSTEM
N NETWORK
U1 USER
U20 FACILITY STAFF
U21 FACILITY STAFF
U2n FACILITY STAFF
U3 AREA STAFF
100 USER TERMINAL
110 STORAGE UNIT
111 PROGRAM
112 TERMINAL INFORMATION
120 MEMORY
130 COMMUNICATION UNIT
140 CAMERA
150 TOUCH PANEL
160 CONTROL UNIT
161 REGISTRATION UNIT
162 PRIVILEGE PROCESSING UNIT
200 AUTHENTICATION APPARATUS
210 FACE INFORMATION DB
211 USER ID
212 FACE FEATURE INFORMATION
220 FACE DETECTION UNIT
230 FEATURE POINT EXTRACTION UNIT
240 REGISTRATION UNIT
250 AUTHENTICATION UNIT
300 PRIVILEGE INFORMATION ISSUING APPARATUS
310 STORAGE UNIT
311 PROGRAM
312 USER INFORMATION
3121 USER ID
3122 TERMINAL INFORMATION
3123 ATTRIBUTE INFORMATION
3124 PAYMENT INFORMATION
3125 ENTRY QUALIFICATION INFORMATION
313 PRIVILEGE INFORMATION MASTER
3131 PRIVILEGE ID
3132 TARGET FACILITY
3133 PRIVILEGE CONTENT
3134 ISSUING CONDITION
3135 AVAILABILITY CONDITION
31351 USED PRIVILEGE ID
314 EVENT INFORMATION
315 PRIVILEGE MANAGEMENT INFORMATION
3151 ISSUED PRIVILEGE ID
3152 USER ID
3153 ISSUING DATE AND TIME
3154 VALIDITY PERIOD
3155 TARGET FACILITY
3156 PRIVILEGE CONTENT
3157 UTILIZATION STATE FLAG
3158 AVAILABILITY CONDITION
320 MEMORY
330 COMMUNICATION UNIT
340 CONTROL UNIT
341 REGISTRATION UNIT
342 AUTHENTICATION CONTROL UNIT
343 SPECIFICATION UNIT
344 ISSUING UNIT
345 NOTIFICATION UNIT
346 ENTRY DETERMINATION UNIT
347 PAYMENT CONTROL UNIT
4 AREA
40 EVENT VENUE
401 ENTRY CONTROL TERMINAL
402 EVENT HALL
403 FIRST COMMERCIAL FACILITY
50 PAYMENT TERMINAL
60 MANAGEMENT TERMINAL
41 SECOND COMMERCIAL FACILITY
51 PAYMENT TERMINAL
61 MANAGEMENT TERMINAL
4n SECOND COMMERCIAL FACILITY
5n PAYMENT TERMINAL
6n MANAGEMENT TERMINAL
600 MANAGEMENT TERMINAL
410 STORAGE UNIT
411 PROGRAM
412 TERMINAL INFORMATION
420 MEMORY
430 COMMUNICATION UNIT
440 CAMERA
450 TOUCH PANEL
460 CONTROL UNIT
461 RECEPTION UNIT
462 ENTRY CONTROL UNIT
510 STORAGE UNIT
511 PROGRAM
512 TERMINAL INFORMATION
520 MEMORY
530 COMMUNICATION UNIT
540 CAMERA
550 TOUCH PANEL
560 CONTROL UNIT
561 RECEPTION UNIT
562 PAYMENT CONTROL UNIT
71 FIRST COUPON
711 UTILIZATION STATE FLAG
712 PRIVILEGE CONTENT
72 SECOND COUPON
721 UTILIZATION STATE FLAG
722 PRIVILEGE CONTENT
723 AVAILABILITY CONDITION
73 FIRST COUPON
731 UTILIZATION STATE FLAG
732 PRIVILEGE CONTENT
74 SECOND COUPON
741 UTILIZATION STATE FLAG
742 PRIVILEGE CONTENT
743 AVAILABILITY CONDITION
71a FIRST COUPON
711a UTILIZATION STATE FLAG
72a SECOND COUPON
721a UTILIZATION STATE FLAG
722a PRIVILEGE CONTENT
724 UPDATE NOTIFICATION MESSAGE
72b SECOND COUPON
721b UTILIZATION STATE FLAG
75 FIRST COUPON
751 UTILIZATION STATE FLAG
752 PRIVILEGE CONTENT
76 FIRST COUPON
761 UTILIZATION STATE FLAG
762 PRIVILEGE CONTENT
77 SECOND COUPON
771 UTILIZATION STATE FLAG
772 PRIVILEGE CONTENT
773 AVAILABILITY CONDITION

What is claimed is:

1. A privilege information issuing apparatus comprising:
at least one storage device configured to store instructions; and
at least one processor configured to execute the instructions to:
issue, for a user who has purchased entry qualification information that enables the user to enter an event venue through identity authentication, first privilege information that is able to be used in a first facility which is any one of a first commercial facility inside the event venue and a second commercial facility in a neighborhood of the event venue and second privilege information in which an availability condition has been set, the availability condition being a condition that the second privilege information is able to be used in a second facility which is the other one of the first commercial facility and the second commercial facility, the second facility being different from the first facility, by a consumption action using the first privilege information being carried out in the first facility; and
notify a terminal of the user of a set of the first privilege information and the second privilege information and the availability condition set in the second privilege information.

2. The privilege information issuing apparatus according to claim 1, wherein the at least one processor is further configured to execute the instructions to:
update the second privilege information to be available in a case where the user has carried out the consumption action using the first privilege information in the first facility, and
notify the terminal of the user of a fact that the second privilege information has become available.

3. The privilege information issuing apparatus according to claim 2, wherein the at least one processor is further configured to execute the instructions to:
determine privilege content of the second privilege information in accordance with a price paid in the consumption action in a case where the user has carried out the consumption action using the first privilege information in the first facility, and
notify the terminal of the user of the determined privilege content of the second privilege information.

4. The privilege information issuing apparatus according to claim 1, wherein the at least one processor is further configured to execute the instructions to:
select privilege information that satisfies an issuing condition on the basis of attribute information associated with the user in advance from among a plurality of pieces of the first privilege information that is able to be used in the first facility, and issue the selected privilege information as the first privilege information.

5. The privilege information issuing apparatus according to claim 4, wherein the at least one processor is further configured to execute the instructions to:
determine a priority of a notification on the basis of the attribute information associated with the user in advance for each of the plurality of pieces of first privilege information, selects two or more pieces of privilege information that satisfies the issuing condition in accordance with the priority, and issues each piece of the selected privilege information as the first privilege information, and
provide a notification of the first privilege information in accordance with the priority.

6. The privilege information issuing apparatus according to claim 1, wherein the at least one processor is further configured to execute the instructions to:
select and issues a set of the first privilege information and the second privilege information that satisfies an issuing condition on the basis of attribute information associated with the user in advance from among a plurality of pieces of the first privilege information that is able to be used in the first facility and a plurality of pieces of the second privilege information that is able to be used in the second facility.

7. The privilege information issuing apparatus according to claim 1, wherein the at least one processor is further configured to execute the instructions to:
register identity authentication information for registration of the user and terminal information owned by the user in an associated manner in a storage apparatus,
refer to the storage apparatus using identity authentication information for authentication of the user and control identity authentication in a case where the identity authentication information for authentication of the user and the entry qualification information are received,
issue the first privilege information and the second privilege information in a case where the identity authentication has successfully been performed, and
notify the terminal of the user as a destination of the terminal information associated with the identity authentication information with which the identity authentication has successfully been performed.

8. A privilege information issuing system comprising:
a storage apparatus that stores first privilege information that is able to be used in a first facility which is any one of a first commercial facility inside an event venue and a second commercial facility in a neighborhood of the event venue and second privilege information that is able to be used in a second facility which is the other one of the first commercial facility and the second commercial facility, the second facility being different from the first facility; and
a privilege information issuing apparatus that is connected to the storage apparatus, and including:
at least one storage device configured to store instructions; and
at least one processor configured to execute the instructions to:
issue, for a user who has purchased entry qualification information that enables the user to enter the event venue through identity authentication, the first privilege information and the second privilege information in which an availability condition has been set with reference to the storage apparatus, the availability condition being a condition that the second privilege information is able to be used by a consumption action using the first privilege information being carried out in the first facility, and
notify a terminal of the user of a set of the first privilege information and the second privilege information and the availability condition set in the second privilege information.

9. The privilege information issuing system according to claim 8, wherein the at least one processor is further configured to execute the instructions to:
update the second privilege information to be available in a case where the user has carried out the consumption action using the first privilege information in the first facility, and
notify the terminal of the user of a fact that the second privilege information has become available.

10. A privilege information issuing method causing a computer to:
issue, for a user who has purchased entry qualification information that enables the user to enter an event venue through identity authentication, first privilege information that is able to be used in a first facility which is any one of a first commercial facility inside the event venue and a second commercial facility in a neighborhood of the event venue and second privilege information in which an availability condition has been set, the availability condition being a condition that the second privilege information is able to be used in a second facility which is the other one of the first commercial facility and the second commercial facility, the second facility being different from the first facility, by a consumption action using the first privilege information being carried out in the first facility; and
notify a terminal of the user of a set of the first privilege information and the second privilege information and the availability condition set in the second privilege information.

11. A non-transitory computer-readable medium that stores a privilege information issuing program that causes a computer to execute:
issuing processing of issuing, for a user who has purchased entry qualification information that enables the user to enter an event venue through identity authentication, first privilege information that is able to be used in a first facility which is any one of a first commercial facility inside the event venue and a second commercial facility in a neighborhood of the event venue and second privilege information in which an availability condition has been set, the availability condition being a condition that the second privilege information is able to be used in a second facility which is the other one of the first commercial facility and the second commercial facility, the second facility being different from the first facility, by a consumption action using the first privilege information being carried out in the first facility; and
notification processing of notifying a terminal of the user of a set of the first privilege information and the second privilege information and the availability condition set in the second privilege information.
